(19) United States
(12) Patent Application Publication
(10) Pub. No.: US 2009/0049147 A1
(43) Pub. Date: Feb. 19, 2009

(54) RECIPIENT APPARATUS, FILE SERVER APPARATUS AND PROGRAM

(76) Inventors: Takehisa Kato, Fuchu-shi (JP); Kouichi Okamoto, Sagamihara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/187,731

(22) Filed: Aug. 7, 2008

(30) Foreign Application Priority Data
Aug. 10, 2007 (JP) 2007-209757

(51) Int. Cl. G06F 15/16

(52) U.S. Cl. 709/206

(57) ABSTRACT

A recipient apparatus and a file server apparatus respectively receive shared mails which are generated by performing secret sharing of an electronic mail from a sender apparatus by a mail server apparatus. The file server apparatus authenticates the recipient apparatus based on an account and transmits shared data to the recipient apparatus when authentication is successful. The recipient apparatus restores the electronic mail with the shared data and shared data in the shared mail which is previously received.

### CROSS-REFERENCE TO RELATED APPLICATIONS

This application is based upon and claims the benefit of priority from prior Japanese Patent Application No. 2007-209757, filed Aug. 10, 2007, the entire contents of which are incorporated herein by reference.

### BACKGROUND OF THE INVENTION

1. Field of the Invention

The present invention relates to a recipient apparatus, a file server apparatus and a program for an electronic mail, and for example, relates to a recipient apparatus, a file server apparatus and a program which can prevent erroneous transmission of an electronic mail due to errors in input or selection of a destination address.

2. Description of the Related Art

For example, with an electronic mail system, when transmitting an electronic mail including a mail text or an attachment, the electronic mail is transmitted based on an input or selected destination address.

Therefore, when the destination address is erroneous, there arises a problem that the electronic mail is transmitted to a party to whom it should not be transmitted.

To prevent such a problem, a method of not transmitting an electronic mail to addresses other than previously set destination addresses has been proposed (see Jpn. Pat. Appln. KOKAI Publication No. 6-46086, for example).

Further, a method of transmitting an electronic mail based on a corresponding destination address by specifying one or more kinds of information among user identification information such as a destination address, a telephone number, an address, a name and the like which are previously related, has been proposed (see Jpn. Pat. Appln. KOKAI Publication No. 2004-56191, for example).

However, with the abovementioned methods of electronic mail transmission, when the input or selection of the destination address is erroneous within the destination address group or the user identification information group which is previously set, there is a problem that the electronic mail is transmitted to a party to whom it should not be transmitted.

### BRIEF SUMMARY OF THE INVENTION

An object of the present invention is to provide a recipient apparatus, a file server apparatus and a program which can prevent erroneous transmission of an electronic mail due to errors in input or selection of a destination address.

In a first aspect of the present invention, there is provided a recipient apparatus capable of communicating with each of a mail server apparatus and a file server apparatus, comprising: a storage device to store a remaining shared mail other than a part of shared mails in the case where the mail server apparatus creates a shared data ID and a plurality of shared mails including a plurality of shared data and a header part of an electronic mail by performing secret sharing of a message main body of the electronic mail which is transmitted from a sender apparatus and the file server apparatus receives the part of the shared mails out of the shared mails; a device configured to write the remaining shared mail into the storage device when the remaining shared mail is received from the mail server apparatus; a device configured to transmit an access request including creation date and time information, destination information, sender information and subject information in the header part to the file server apparatus; a device configured to transmit account information including an input user ID and the shared data ID to the file server apparatus when an authentication request is received from the file server apparatus after the transmission of the access request; and a restoration device configured to restore the electronic mail based on a part of the shared data received from the file server apparatus and the shared data included in the remaining shared mail in the storage device after the file server apparatus performs an authentication based on the account information.

In a second aspect of the present invention, there is provided a file server apparatus capable of communicating with each of a mail server apparatus and a recipient apparatus, comprising: a shared mail storage device to store a remaining shared mail other than a part of shared mails in the case where the mail server apparatus creates a shared data ID and a plurality of shared mails including a plurality of shared data and a header part of an electronic mail by performing secret sharing of a message main body of the electronic mail which is transmitted from a sender apparatus and the recipient apparatus receives the part of the shared mails out of the shared mails; an account information storage device which stores account information including a user ID and a shared data ID; a device configured to write the account information transmitted from the sender apparatus into the account information storage device; a device configured to write the remaining shared mail into the shared mail storage device when the remaining shared mail is received from the mail server apparatus; a device configured to transmit an authentication request to the recipient apparatus when an access request including creation date and time information, destination information, sender information and subject information in the header part is received from the recipient apparatus; a device configured to receive account information including a user ID and a shared data ID from the recipient apparatus after the transmission of the authentication request; a device configured to authenticate the recipient apparatus based on the account information received from the recipient apparatus and the account information in the account information storage device and to deliver the access request when authentication is successful; and a device configured to transmit the corresponding shared data in the shared mail storage device to the recipient apparatus based on the delivered access request.

In a third aspect of the present invention, there is provided a file server apparatus capable of communicating with each of a mail server apparatus and a recipient apparatus, comprising: a shared mail storage device to store a remaining shared mail other than a part of shared mails in the case where the mail server apparatus creates a shared data ID and a plurality of shared mails including a plurality of shared data and a header part of an electronic mail by performing secret sharing of a message main body of the electronic mail which is transmitted from a sender apparatus and the recipient apparatus receives the part of the shared mails out of the shared mails; an account information storage device which stores account information including a user ID and a shared data ID; a device configured to write the account information transmitted from the sender apparatus into the account information storage device; a device configured to write the remaining shared mail into the shared mail storage device when the remaining shared mail is received from the mail server apparatus; a device configured to transmit an authentication request to the recipient apparatus when an access request including creation date and time information, destination information, sender information and subject information in the header part is received from the recipient apparatus; a device configured to receive account information including a user ID and a shared data ID from the recipient apparatus after the transmission of the authentication request; a device configured to authenticate the recipient apparatus based on the account information received from the recipient apparatus and the account information in the account information storage device and to deliver the access request when authentication is successful; a device configured to read the shared data corresponding to the delivered access request from the shared mail storage device; a device configured to transmit a shared data request to the recipient apparatus when authentication is successful; a device configured to restore the electronic mail based on the shared data received from the recipient apparatus and the shared data read from the shared mail storage device after the transmission of the shared data request; and a device configured to transmit the restored electronic mail to the recipient apparatus.

With the first aspect and the second aspect, the recipient apparatus and the file server apparatus respectively receive each shared mail obtained by secret sharing of an electronic mail. The file server apparatus authenticates the recipient apparatus based on an account and transmits the shared data to the recipient apparatus when authentication is successful. The recipient apparatus restores the electronic mail from this shared data and the shared data in the previously received shared mail.

In this manner, even when an error of the mail address occurs, the original electronic mail cannot be restored from the received shared mail because the recipient does not have the account for the file server. Therefore, erroneous transmission of an electronic mail due to errors in input or selection of the destination address can be prevented.

With the third aspect, the recipient apparatus and the file server apparatus respectively receive each shared mail obtained by secret sharing of an electronic mail. The file server apparatus authenticates the recipient apparatus based on an account and transmits a shared data request to the recipient apparatus when authentication is successful. In accordance with the shared data request, the recipient apparatus transmits the shared data in the previously received shared mail to the file server apparatus. The file server apparatus restores the electronic mail from this shared data and the shared data in the previously received shared mail and transmits the electronic mail to the recipient apparatus.

In this manner, even when an error of the mail address occurs, the restored electronic mail cannot be obtained because the recipient does not have the account for the file server. Therefore, erroneous transmission of electronic mail due to errors in input or selection of the destination address can be prevented.

### BRIEF DESCRIPTION OF THE SEVERAL VIEWS OF THE DRAWINGS

FIGS. 1 and 2 are schematic diagrams showing a structure of an electronic mail system to which a recipient apparatus and a file server apparatus according to a first embodiment of the present invention are applied;

FIG. 3 is a schematic diagram for explaining an electronic mail, a shared data header part and shared data of the first embodiment;

FIG. 4 is a schematic diagram for explaining a shared mail of the first embodiment;

FIG. 5 is a schematic diagram showing a structure of an account information storage portion of the first embodiment;

FIG. 6 is a flowchart for explaining the operation of the first embodiment;

FIG. 7 is a sequence diagram for explaining the operation of the first embodiment;

FIG. 8 is a schematic diagram showing a structure of an electronic mail system according to a second embodiment of the present invention;

FIG. 9 is a sequence diagram for explaining the operation of the second embodiment;

FIG. 10 is a schematic diagram showing an example of a screen for upload setting of the second embodiment;

FIGS. 11 and 12 are schematic diagrams showing a structure of an electronic mail system according to a third embodiment of the present invention;

FIG. 13 is a schematic diagram showing a modified example of the third embodiment;

FIGS. 14 and 15 are schematic diagrams showing a structure of an electronic mail system according to a fourth embodiment of the present invention;

FIG. 16 is a sequence diagram for explaining the operation of the fourth embodiment;

FIG. 17 is a schematic diagram showing a structure of an electronic mail system according to a fifth embodiment of the present invention;

FIG. 18 is a sequence diagram for explaining the operation of the fifth embodiment;

FIG. 19 is a sequence diagram showing operation of an electronic mail system according to a sixth embodiment of the present invention;

FIG. 20 is a schematic diagram showing a structure of an electronic mail system according to a seventh embodiment of the present invention;

FIG. 21 is a sequence diagram for explaining the operation of the seventh embodiment;

FIG. 22 is a schematic diagram showing a structure of an electronic mail system according to an eighth embodiment of the present invention;

FIG. 23 is a sequence diagram for explaining the operation of the eighth embodiment;

FIG. 24 is a sequence diagram showing operation of an electronic mail system according to a ninth embodiment of the present invention;

FIGS. 25 and 26 are schematic diagrams showing a structure of an electronic mail system according to a tenth embodiment of the present invention;

FIGS. 27, 28 and 29 are diagrams showing modified examples of the tenth embodiment; and

FIG. 30 is a schematic diagram showing an arrangement of shared data of an electronic mail system according to an eleventh embodiment of the present invention.

### DETAILED DESCRIPTION OF THE INVENTION

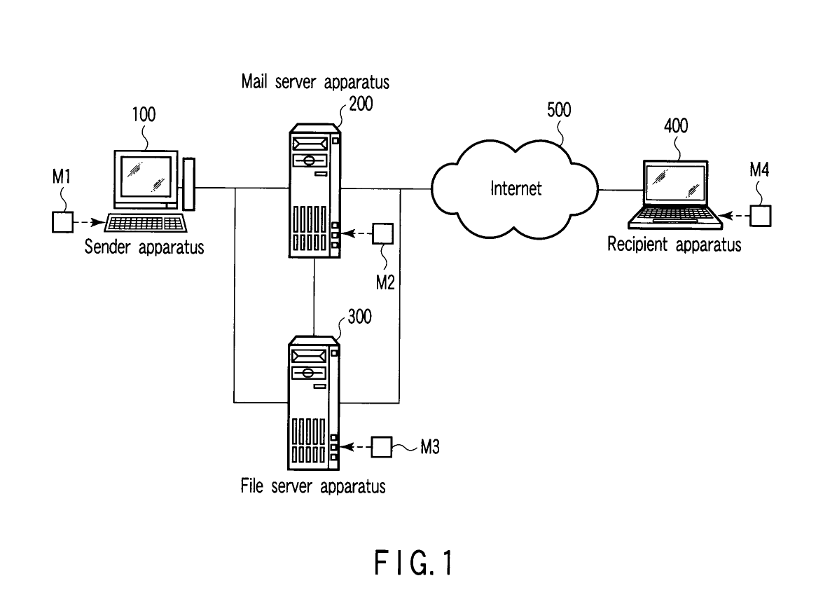

In the following, each embodiment of the present invention will be explained with reference to the drawings. Here, on each apparatus basis, each apparatus in the following can be utilized as the structure of either a hardware structure or a combination structure of a hardware resource and software. As the software for the combination structure, a program which is previously installed to computers of apparatuses 100, 200, 300, 400 and 600 from corresponding network or storage media M1, M2, M3, M4 and M6 and which realizes the functions of the corresponding apparatuses is utilized, as shown in FIGS. 1, 11, 14 and 25 for example.

### First Embodiment

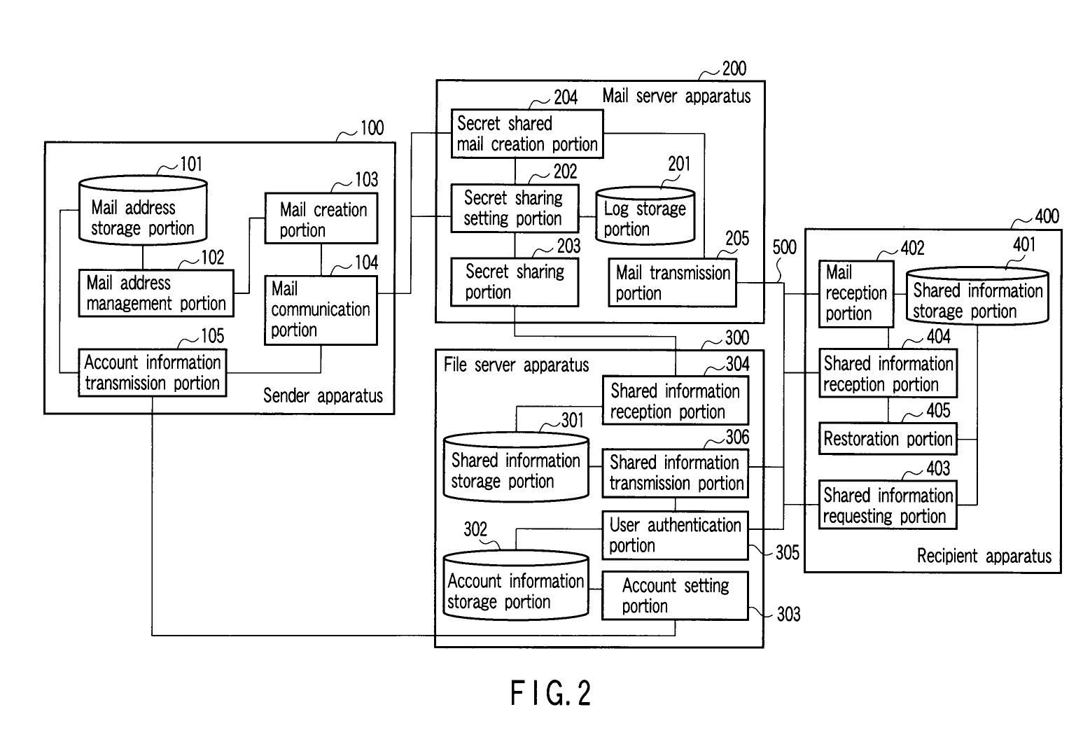

FIGS. 1 and 2 are schematic diagrams showing a structure of an electronic mail system to which a recipient apparatus and a file server apparatus according to the first embodiment of the present invention are applied. In the electronic mail system, a mail server apparatus 200 and a file server apparatus 300 which are respectively connected to a sender apparatus 100 are connected to a recipient apparatus 400 through the internet 500.

Here, the sender apparatus 100 is for creating and transmitting an electronic mail for a recipient in accordance with an operation of a sender and has a function to transmit account information of the recipient to the file server apparatus 300 in accordance with an operation of the sender.

Specifically, the sender apparatus 100 includes a mail address storage portion 101, a mail address management portion 102, a mail creation portion 103, a mail communication portion 104 and an account information transmission portion 105.

The mail address storage portion 101 is a storage device which is accessible from the mail address management portion 102 and the account information transmission portion 105. A user ID of each user, a user name and a mail address are stored in association with one another. Further, it is also possible that address information other than the mail such as an affiliation, a telephone number and the like, is stored.

The mail address management portion 102 has the following functions of (f102-1) and (f102-2).

(f102-1): A function of previously writing the user address information such as a user ID, a user name, and a mail address, into the mail address storage portion 101 in accordance with an operation of the sender.

(f102-2): A function of reading the user address information in the mail address storage portion 101 while being controlled by the mail creation portion 103.

The mail address management portion 102 can also have a function of referring to a Lightweight Directory Access Protocol (LDAP) address list.

The mail creation portion 103 has the following functions of (f103-1) and (f103-2).

(f103-1): A function of creating an electronic mail including a mail text and/or attached data in accordance with an operation of the sender.

(f103-2): A function of selecting a destination address and a secret sharing method (an secret sharing algorithm, a threshold value k, sharing number n and the like) while referring to the user address information in the mail address storage portion 101 through the mail address management portion 102, setting the selected items to an electronic mail and delivering the electronic mail to the mail communication portion 104.

The mail communication portion 104 has the following functions of (f104-1) through (f104-3).

(f104-1): A function of transmitting the electronic mail which is received from the mail creation portion 103 to the mail server apparatus 200.

(f104-2): A function of delivering an account creation request to the account information transmission portion 105 when the request is received from the mail server apparatus 200.

(f104-3): A function of transmitting a notice of account setting completion, which is received from the account information transmission portion 105, to the mail server apparatus 200.

The account information transmission portion 105 has the following functions of (f105-1) and (f105-2).

(f105-1): A function of transmitting the account information including a shared data ID and a user ID while referring to the user address information in the mail address storage portion 101 and an access list in an account information storage portion 302 of the file server apparatus 300 based on the account creation request which is received from the mail communication portion 104 in accordance with an operation of the sender.

(f105-2): A function of delivering the notice of account setting completion, which is received from the file server apparatus 300, to the mail communication portion 104.

The mail server apparatus 200 is for creating a shared data ID and a plurality of shared mails including a plurality of shared data and a header part of the electronic mail by performing secret sharing of the message main body of the electronic mail which is transmitted from the sender apparatus 100, transmitting a part of the shared mails out of the shared mails to the file server apparatus 300 and transmitting the remaining shared mails to the recipient apparatus 400.

Specifically, the mail server apparatus 200 includes a log storage portion 201, a secret sharing setting portion 202, a secret sharing portion 203, and a secret shared mail creation portion 204 and a mail transmission portion 205.

The log storage portion 201 is a storage device which is accessible from the secret sharing setting portion 202. Transmitting and receiving data which is related to date and time data is written into the log storage portion 201 as a log.

The secret sharing setting portion 202 has the following functions of (202-1) and (f202-2).

(f202-1): A function of receiving the electronic mail from the sender apparatus 100, and a function of setting the secret sharing method (the secret sharing algorithm, the threshold value k, the sharing number n and the like) which is set at the received electronic mail to the secret sharing portion 203 and the secret shared mail creation portion 204.

(f202-2): A function of writing the transmitting and receiving data of each portion of 202 through 205 in association with the date and time data into the log storage portion 201.

Here, the (k, n) threshold method is utilized as the secret sharing method. According to the (k, n) threshold method, secret information is divided into n items of shared information. Although the original secret information can be restored when any k items out of n items of shared information are collected, the original secret information cannot be obtained at all from k−1 items of shared information. Namely, the (k, n) threshold method has restoration characteristics of the shared information with the threshold value k as the boundary (where, 1<k≦n). Therefore, with the (k, n) threshold method, the original secret information is safe even when the shared information of k−1 items or less leaks, and there is an advantage that the original secret information can be restored even when the shared information of n-k items or less is lost.

The secret sharing portion 203 has the following functions of (f203-1) and (f203-2).

(f203-1): A function of performing secret sharing of the message main body of the electronic mail in accordance with the secret sharing method which is set at the secret sharing setting portion 202 and creating the shared data of sharing number n items.

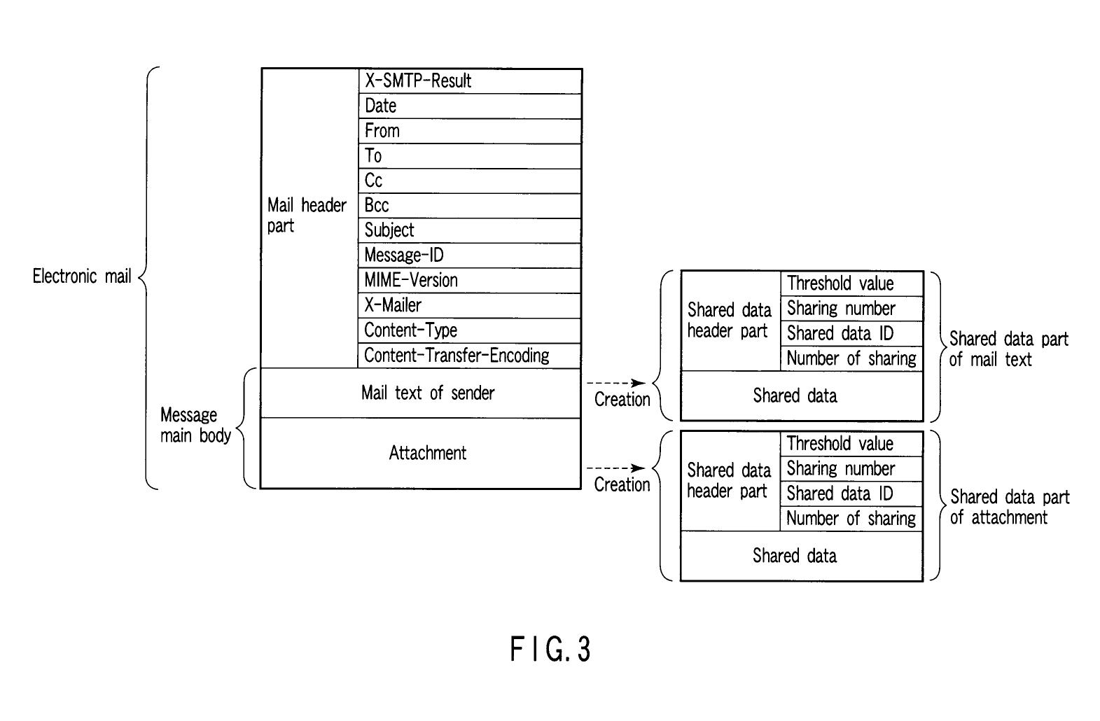

(f203-2): A function of delivering the shared data of less than threshold value k items to the secret shared mail creation portion 204 and transmitting the remainder of the shared data and the mail header part of the electronic mail to the file server apparatus 300. Here, as shown at the left side in FIG. 3, the electronic mail is composed of the mail header part and the message main body (the mail text of the sender and the attachment in the figure). As shown at the right-upper side in FIG. 3, a shared data part which includes the shared data header part and the shared data is created from the mail text of the sender. Similarly, as shown in the right-lower side in FIG. 3, a shared data part which includes the shared data header part and the shared data is created from the attachment. Here, it is also possible to create a shared data part which includes the shared mail header part and the shared data from the message main body (the mail text of the sender and the attachment).

The secret shared mail creation portion 204 has the following functions of (f204-1) through (f204-4).

(f204-1): A function of creating the shared data header part for each shared data based on the secret sharing method which is set by the secret sharing setting portion 202.

(f204-2): A function of creating the shared data part which includes the shared data header part and the shared data and the shared mail which includes the mail text for notice and the mail header part of the electronic mail.

(f204-3): A function of transmitting the account creation request which includes the shared data ID to the sender apparatus 100.

(f204-4): A function of delivering the shared mail to the mail transmission portion 205 when the notice of account setting completion is received from the sender apparatus 100.

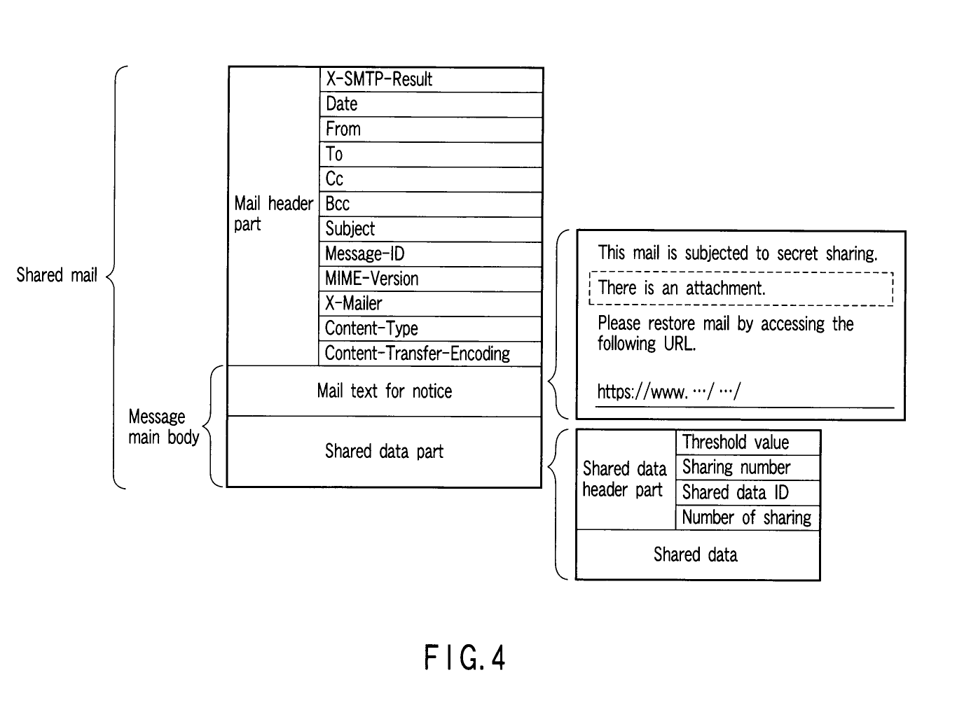

Here, as shown in FIG. 4, the shared mail is the electronic mail which is composed of the mail header part and the message main body (the mail text for notice and the shared data part in the figure). The mail header part is the mail header part of the electronic mail before secret sharing and composed of ordinary header information. The header information is described in the form of “a field name: value” (not shown in figures). The field name includes X-*** (enlarged field), Date (creation date and time), From (creator [sender]), To (recipient [destination]), Cc (secondary recipient [destination]), Bcc (secondary recipient [destination]), Subject (subject name), Message-ID (message identifier), MIME-Version (version), Content-Type (data type), Content-Transfer-Encoding (encoding method) and the like.

The mail text (the mail text for notice) of the shared mail includes a notice of having an attachment in the case where the electronic mail before secret sharing has the attachment, for example, and URL (uniform resource locator) of the file server apparatus 300.

The shared data part of the shared mail (the bottom part) shown in FIG. 4 is the attachment and is composed of the shared data header part and the shared data. Here, not being limited to the attachment, the shared data part of the shared mail can also be described as a part of the mail text.

The shared data header part in the attachment shown in FIG. 4 is composed of a threshold value, sharing number, a shared data ID and number of sharing for each shared data based on the secret sharing method which is set by the secret sharing setting portion 202. The shared data header part includes the same threshold value, the same sharing number, the same shared data ID and different number of sharing from that of other shared data which are different from one another. Further, the shared data header part is created separately for each of the mail text (the mail text of a sender) of the original electronic mail and the attachment of the original electronic mail, and separate shared data ID is given.

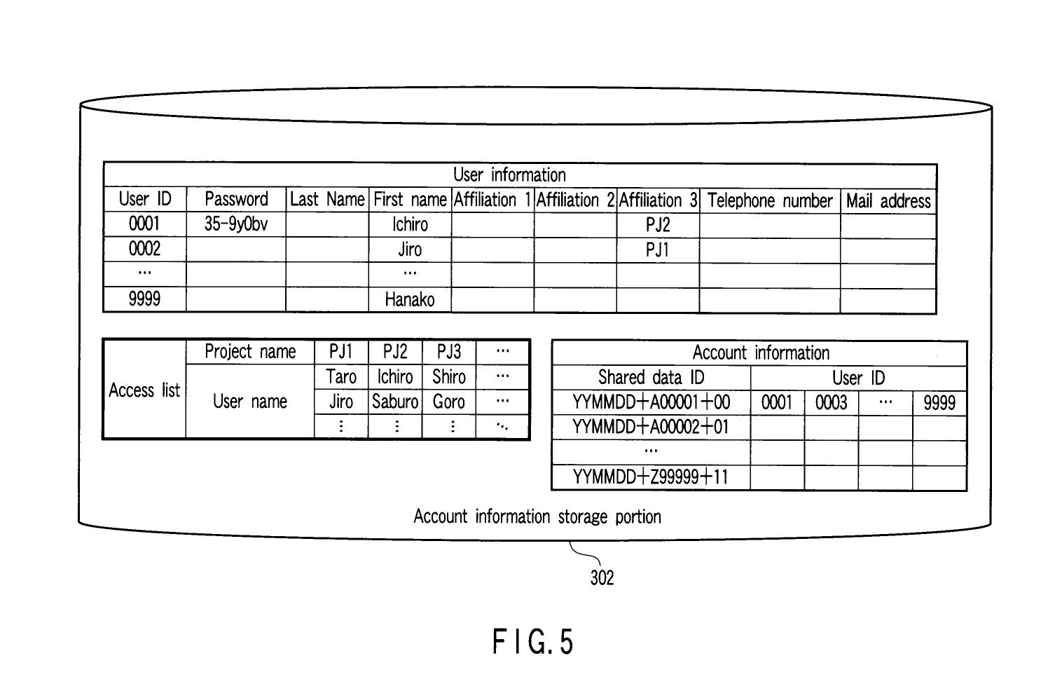

As an example is shown in FIG. 5 described later, the shared data ID includes date and time data (shown as YYMMDD in the figure), a sequence number (shown as A00001, etc., in the figure) and a flag (shown as 00, 01 or 11 in the figure). The date and time data indicates the creation date and time of the shared data. The sequence number indicates identification information of the electronic mail. The flag indicates the state of the electronic mail whether it is a mail text and/or an attachment. Here, the flag “00” indicates that the state of the electronic mail is with a mail text and without an attachment. The flag “01” indicates that the state of the electronic mail is with a mail text and with an attachment. The flag “11” indicates that the state of the electronic mail is without a mail text and with an attachment.

The number of sharing indicates a sequential position of the shared data in the same shared data ID.

The mail transmission portion 205 has a function of transmitting the shared mail which is received from the secret shared mail creation portion 204 to the recipient apparatus 400 through the internet 500.

The file server apparatus 300 is for storing the shared mail which is received from the mail server apparatus 200 and for transmitting the shared data in the stored shared mail to the recipient apparatus 400 when authenticating the account of the recipient apparatus 400 is successful.

Specifically, the file server apparatus 300 includes a shared information storage portion 301, an account information storage portion 302, an account setting portion 303, a shared information reception portion 304, a user authentication portion 305 and a shared information transmission portion 306.

The shared information storage portion 301 is a storage device which is accessible from the shared information reception portion 304 and the shared information transmission portion 306 and stores the shared data and the mail header part of the electronic mail.

The account information storage portion 302 is a storage device which is accessible from the account setting portion 303 and the user authentication portion 305 and stores user information, an access list and account information as shown in FIG. 5. Here, the user information shows a password, a last name, a first name, affiliations 1 through 3 and a telephone number for each user ID which indicates a user. The access list is for showing user name of a user who is accessible to the file server apparatus 300 for each project name. The account information is for showing a user ID of a user who is accessible for each shared data ID.

The account setting portion 303 has a function of setting account information which includes the shared data ID and the user ID transmitted from the sender apparatus 100 to the account information storage portion 302 and a function of transmitting a notice of the account setting completion to the sender apparatus 100 after the setting.

The shared information reception portion 304 has a function of receiving the shared data and the mail header part from the mail server apparatus 200 and a function of writing the received shared data and mail header part into the shared information storage portion 301.

The user authentication portion 305 has the following functions of (f305-1) and (f305-2).

(f305-1): A function of transmitting an authentication request to the recipient apparatus 400 when an access request is received from the recipient apparatus 400.

(305-2): A function of performing user authentication based on the user information and the account information in the account information storage portion 302 when the user ID, the password and the shared data ID are received from the recipient apparatus 400 and delivering the aforementioned access request to the shared information transmission portion 306 when authentication is successful. Here, the authentication based on the user ID and the password is the authentication of an access authority to the file server apparatus 300. The authentication based on the user ID and the shared data ID is the account authentication of the shared data (the account authentication for each electronic mail). The two authentications are collectively referred to as user authentication. From the viewpoint of preventing erroneous transmission of an electronic mail, the account authentication is indispensable but the authentication of the access authority can be omitted.

The shared information transmission portion 306 has a function of transmitting the corresponding shared data in the shared information storage portion 301 to the recipient apparatus 400 based on the creation date and time information, the destination information, the sender information and the subject information in the access request when the access request is received from the user authentication portion 305.

The recipient apparatus 400 is for storing the shared mail which is received from the mail server apparatus 200, receiving other shared data from the file server apparatus 300 when authentication is successful after transmitting the account information to the file server apparatus 300, and restoring the original electronic mail from this shared data and the shared data in the stored shared mail.

Specifically, the recipient apparatus 400 has a shared information storage portion 401, a mail reception portion 402, a shared information requesting portion 403, a shared information reception portion 404 and a restoration portion 405.

The shared information storage portion 401 is a storage device which is accessible from the mail reception portion 402, the shared information requesting portion 403 and the restoration portion 405, and the shared data which is received by the mail reception portion 402 and the electronic mail which is restored by the restoration portion 405 are stored.

The mail reception portion 402 has a function of receiving the shared mail from the mail server apparatus 200 and a function of writing the received shared mail into the shared information storage portion 401.

The shared information requesting portion 403 has the following functions of (f403-1) and (f403-2).

(f403-1): A function of transmitting the access request which includes the creation date and time information (Date: value), the destination information (To: value, Cc: value and Bcc: value), the sender information (From: value) and the subject information (Subject: value) in the mail header part of the electronic mail to the file server apparatus 300 in accordance with an operation of the recipient.

(f403-2): A function of transmitting the user ID, the password and the shared data ID to the file server apparatus 300 in accordance with an operation of the recipient when the authentication request is received from the file server apparatus 300.

The shared information reception portion 404 has a function of receiving the shared data from the file server apparatus 300 and a function of delivering the shared data to the restoration portion 405.

The restoration portion 405 has a function of restoring the electronic mail based on the shared data which is received from the shared information reception portion 404 and the shared data which is included in the shared mail in the shared information storage portion 401 and browsing the electronic mail.

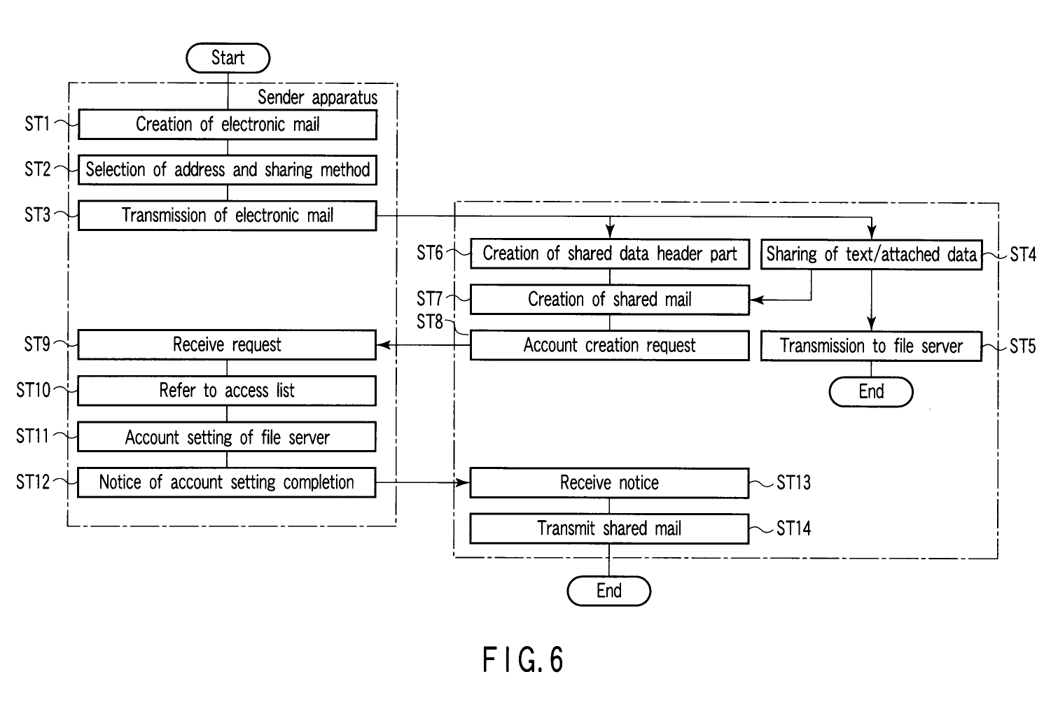

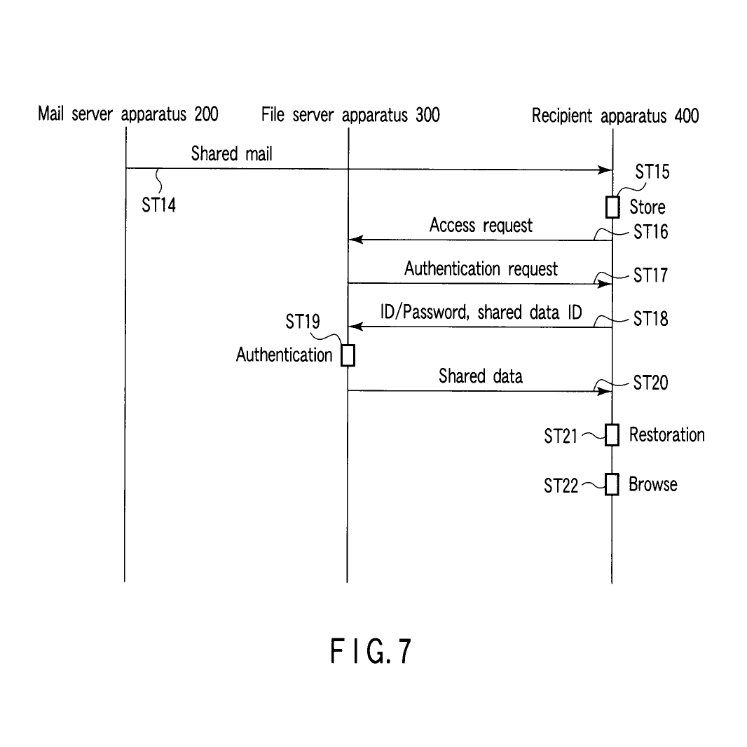

Next, the operation of the electronic mail system configured as abovementioned will be explained by utilizing FIGS. 6 and 7.

(Mail Transmission)

As shown in FIG. 6, in the sender apparatus 100, the mail creation portion 103 creates the electronic mail which includes the mail text and/or the attachment in accordance with an operation of the sender (ST1).

At this time, the mail creation portion 103 selects the destination address and the secret sharing method (the secret sharing algorithm, the threshold value k, the sharing number n and the like) referring to the user information in the mail address storage portion 101 through the mail address management portion 102 in accordance with an operation of the sender (ST2), and then, sets the selected items to the electronic mail and delivers the electronic mail to the mail communication portion 104, which in turn transmits the electronic mail to the mail server apparatus 200 (ST3).

In the Mail Server Apparatus 200, the Secret sharing setting portion 202 sets the secret sharing method, which is set to the electronic mail, to the secret sharing portion 203 and the secret shared mail creation portion 204 when the electronic mail is received.

The secret sharing portion 203 performs secret sharing of the mail text and/or the attachment of the electronic mail based on the set secret sharing method and creates the sharing number n items of shared data (ST4).

The secret sharing portion 203 delivers less than the threshold value k items of shared data out of n items of shared data to the secret shared mail creation portion 204 and transmits the remaining shared data and the mail header part of the electronic mail to the file server apparatus 300 (ST5).

In the file server apparatus 300, the shared information reception portion 304 receives the shared data and the mail header part and writes them into the shared information storage portion 301.

On the other hand, in the mail server apparatus 200, the secret shared mail creation portion 204 creates the shared data header part which includes the threshold value, the sharing number, the shared data ID and the number of sharing for each shared data based on the secret sharing method which is set by the secret sharing setting portion 202 (ST6).

Further, the secret shared mail creation portion 204 creates the shared mail (the electronic mail for sharing) which includes the shared data header part, the shared data and the mail header part of the original electronic mail (ST7).

Then, the secret shared mail creation portion 204 transmits the account creation request which includes the shared data ID to the sender apparatus 100 (ST8).

In the sender apparatus 100, when the mail communication portion 104 receives the account creation request (ST9), the request is delivered to the account information transmission portion 105.

Referring to the user information in the mail address storage portion 101 and the access list in the account information storage portion 302 of the file server apparatus 300 (ST10), the account information transmission portion 105 transmits the account information which includes the shared data ID and the user ID to the file server apparatus 300 based on the request in accordance with an operation of the sender.

In the file server apparatus 300, after the account information is set to the account information storage portion 302 (ST11), the account setting portion 303 transmits the notice of the account setting completion to the sender apparatus 100.

In the sender apparatus 100, the notice of the account setting completion is transmitted to the mail server apparatus 200 (ST12).

In the mail server apparatus 200, when the notice is received (ST13), the secret shared mail creation portion 204 delivers the shared mail which is created in step ST7 to the mail transmission portion 205.

The mail transmission portion 205 transmits the shared mail to the recipient apparatus 400 through the internet 500 (ST14).

As shown in FIG. 7, in the recipient apparatus 400, the mail reception portion 402 stores the shared mail in the shared mail storage portion 401 after receiving the shared mail (ST15).

(Mail Restoration)

In the recipient apparatus 400, the shared information requesting portion 403 transmits the access request which includes the creation date and time information, the destination information, the sender information and the subject information in the mail header part of the electronic mail to the file server apparatus 300 in accordance with an operation of the recipient (ST16).

In the file server apparatus 300, the user authentication portion 305 transmits the authentication request to the recipient apparatus 400 when the access request is received (ST17).

In the recipient apparatus 400, when the authentication request is received, the shared information requesting portion 403 transmits the user ID, the password and the shared data ID to the file server apparatus 300 in accordance with an operation of the recipient (ST18).

In the file server apparatus 300, the user authentication portion 305 performs user authentication based on the user information and the account information in the account information storage portion 302 when the user ID, the password and the shared data ID are received (ST19). Then, the user authentication portion 305 delivers the access request described in step ST16 to the shared information transmission portion 306 when authentication is successful.

When the access request is received, the shared information transmission portion 306 transmits the corresponding shared data in the shared data storage portion 301 to the recipient apparatus 400 based on the creation date and time information, the destination information, the sender information and the subject information in the access request (ST20).

In the recipient apparatus 400, the restoration portion 405 restores the electronic mail based on the shared data which is received by the shared information reception portion 404 and the shared data which is included in the shared mail stored in step ST15 (ST21) and browses the electronic mail (ST22).

As abovementioned, according to the present embodiment, each shared mail obtained by secret sharing of the electronic mail is respectively received by the recipient apparatus 400 and the file server apparatus 300. The file server apparatus 300 authenticates the recipient apparatus 400 based on the account and transmits the shared data to the recipient apparatus 400 when authentication is successful. The recipient apparatus 400 restores the electronic mail from this shared data and the shared data in the shared mail which is previously received.

In this manner, in the case where a mail address error occurs, the received shared mail cannot be restored because there is no account for the file server apparatus 300 of the recipient to whom the shared mail is transmitted by mistake. Therefore, erroneous transmission of an electronic mail due to errors in input or selection of a destination address can be prevented.

In other words, with the structure according to the present embodiment, after performing secret sharing of the electronic mail, one of them is transmitted to the recipient apparatus 400 as PUSH (shared mail) and the remainder are obtained with the account authentication from the file server apparatus 300. With this structure, even when there is an input error or a selection error of a destination address, the obtainment of the remaining shared data is prevented by the account authentication. Therefore, erroneous transmission of electronic mail due to an input error or a selection error of a destination address can be prevented.

Further, by performing secret sharing of a mail text and an attachment of an electronic mail and transmitting them respectively in different paths to an intended recipient, erroneous transmission due to an error of address can also be prevented.

### Second Embodiment

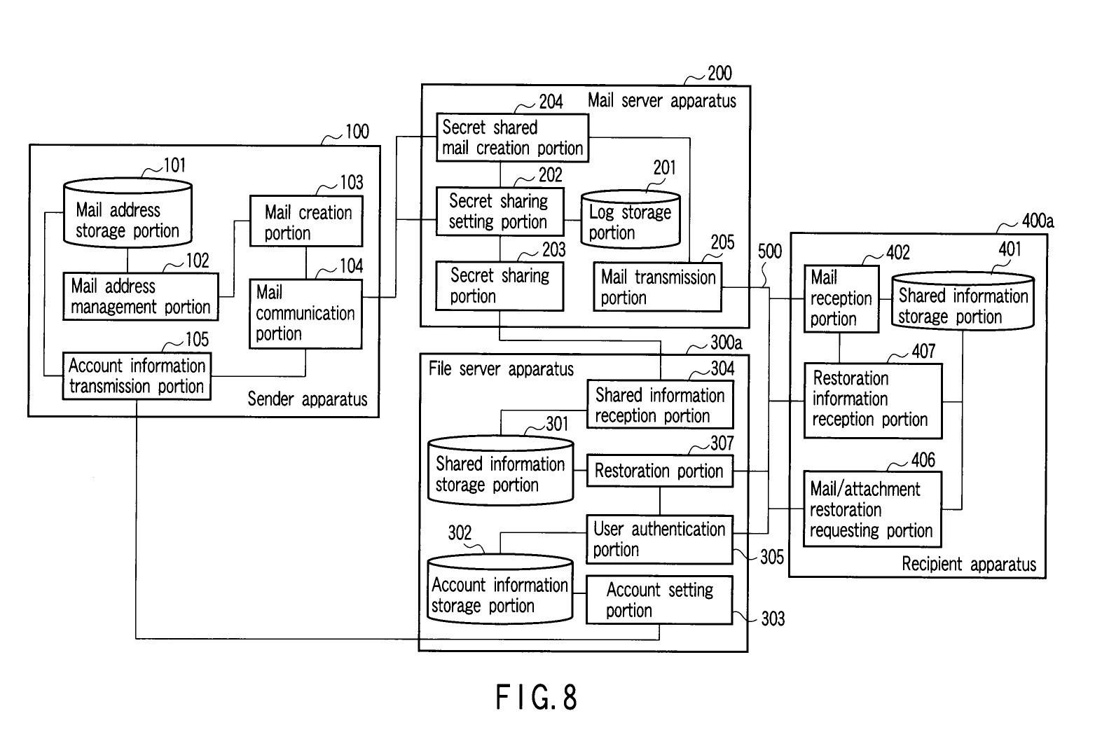

FIG. 8 is a schematic diagram showing a structure of an electronic mail system to which the file server apparatus according to the second embodiment of the present invention is applied. The same reference numeral is given to the same part as in FIG. 2, and detailed explanation thereof is omitted. Here, different parts will be mainly described. Similarly, overlapped explanation is omitted for the following embodiments.

Specifically, unlike the first embodiment which restores the electronic mail at the recipient apparatus 400, the second embodiment is configured to restore the electronic mail at the file server apparatus 300a.

According to this structure, a restoration portion 307 is provided at the file server apparatus 300a in place of the shared information transmission portion 306.

The restoration portion 307 has the following functions of (f307-1) through (f307-4).

(f307-1): A function of reading the corresponding shared data in the shared information storage portion 301 based on the creation date and time information, the destination information, the sender information and the subject information in the access request when the access request is received from the user authentication portion 305.

(f307-2): A function of transmitting the shared data request to the recipient apparatus 400a.

(f307-3): A function of restoring the electronic mail based on the shared data which is received from the recipient apparatus 400a and the shared data which is read from the shared information storage portion 301.

(f307-4): A function of transmitting the restored electronic mail (restored data in the figure) to the recipient apparatus 400a.

On the other hand, the recipient apparatus 400a has a mail/attachment restoration requesting portion 406 and a restoration information reception portion 407 in place of the shared information requesting portion 403, the shared information reception portion 404 and the restoration portion 405.

The mail/attachment restoration requesting portion 406 has the following functions of (f406-1) through (f406-3).

(f406-1): A function of transmitting the access request which includes the creation date and time information, the destination information, the sender information and the subject information in the mail header part of the electronic mail to the file server apparatus 300a in accordance with an operation of the recipient.

(f406-2): A function of transmitting the user ID, the password and the shared data ID to the file server apparatus 300a when the authentication request is received from the file server apparatus 300a.

(f406-3): A function of performing an upload setting of the shared data in the shared information storage portion 401 and transmitting the shared data to the file server apparatus 300a in accordance with an operation of the recipient when the shared data request is received from the file server apparatus 300a.

The restoration information reception portion 407 has a function of writing the electronic mail which is received from the file server apparatus 300a into the shared information storage portion 401 and a function of browsing the electronic mail in the shared information storage portion 401.

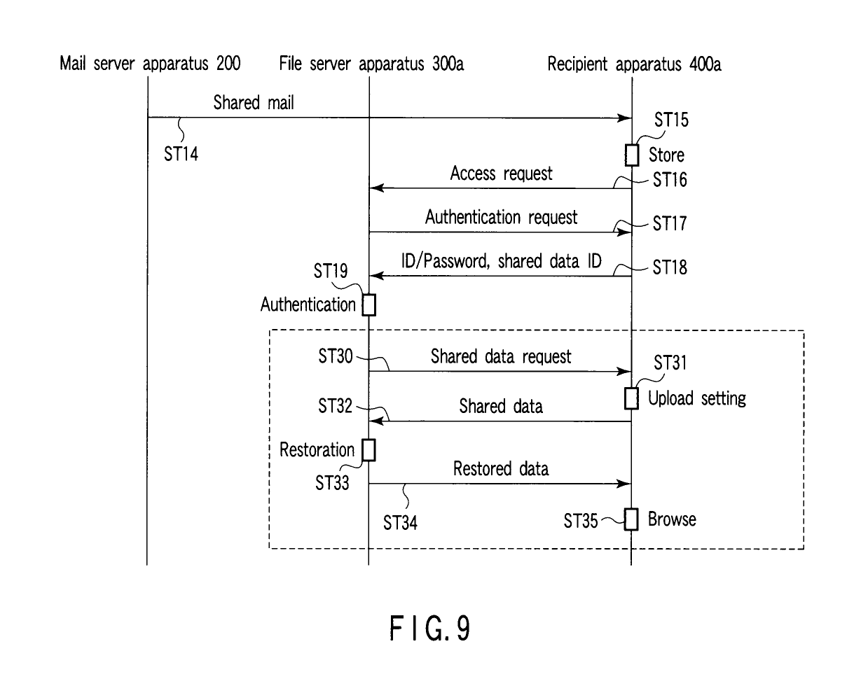

Next, the operation of the electronic mail system which is structured as mentioned above will be explained by utilizing the sequence diagram of FIG. 9. Here, the mail transmission operation of steps ST1 through ST15 is the same as that of the first embodiment. Therefore, the mail restoration operation at step 16 and later will be explained in the following.

(Mail Restoration)

The operation from the access request in step ST16 through user authentication in step ST19 is performed as mentioned above. Here, the portion which performs steps ST16 through ST18 is the mail/attachment restoration requesting portion 406.

Following the completion of step ST19, in the file server apparatus 300a, the restoration portion 307 reads the corresponding shared data in the shared information storage portion 301 based on the creation date and time information, the destination information, the sender information and the subject information in the access request when the access request is received from the user authentication portion 305 and transmits the shared data request to the recipient apparatus 400a (ST30).

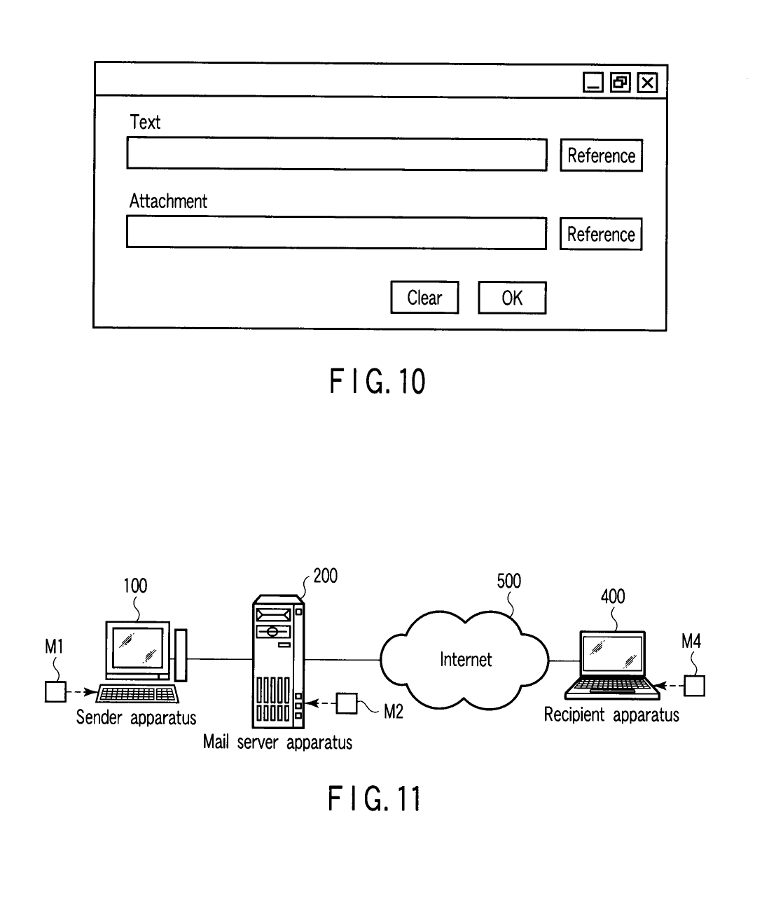

In the recipient apparatus 400a, the mail/attachment restoration requesting portion 406 performs the upload setting of the shared data in the shared information storage portion 401 as shown in FIG. 10 in accordance with an operation of the recipient when the shared data request is received (ST31) and transmits the shared data to the file server apparatus 300a (ST32).

In the file server apparatus 300a, the restoration portion 307 restores the electronic mail based on the shared data which is received from the recipient apparatus 400a and the shared data which is read from the shared information storage portion 301 (ST33) and transmits the obtained electronic mail (restored mail in the figure) to the recipient apparatus 400a (ST34).

In the recipient apparatus 400a, the restoration information reception portion 407 browses the electronic mail in the shared information storage portion 401 after writing the received electronic mail into the shared information storage portion 401 (ST35).

As mentioned above, according to the present embodiment, with the structure in which the electronic mail is restored by the file server apparatus 300a, the similar effect to that of the first embodiment can be obtained.

### Third Embodiment

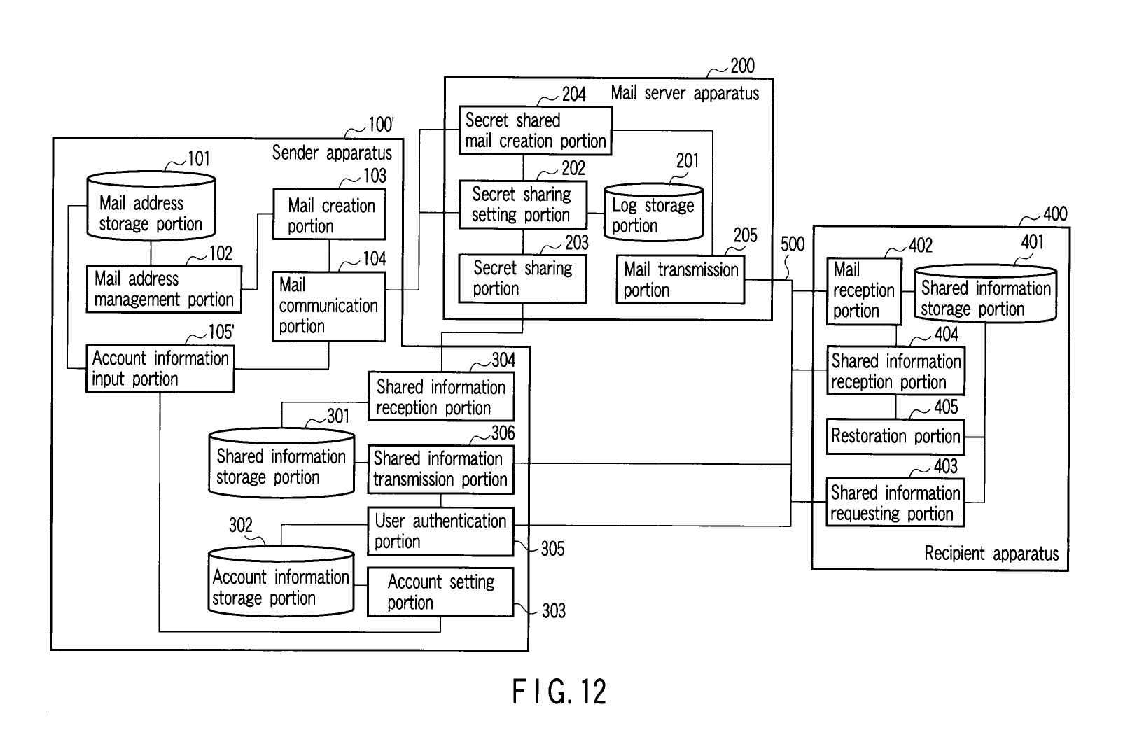

FIGS. 11 and 12 are diagrams showing a structure of an electronic mail system to which the recipient apparatus according to the third embodiment of the present invention is applied.

The third embodiment is a modified example of the first embodiment. As shown in FIG. 12, the third embodiment has a sender apparatus 100′ which is configured to integrate the file server apparatus 300 in FIG. 2 with the sender apparatus 100. Here, according to the integration, an account information input portion 105′ is disposed in place of the account information transmission portion 105 shown in FIG. 2.

The account information input portion 105′ has the following functions of (f105′-1) and (f105′-2).

(f105′-1): A function of inputting the account information which includes the shared data ID and the user ID to the account setting portion 302 with reference to the user address information in the mail address storage portion 101 and the access list in the account information storage portion 302 based on the account creation request which is received from the mail communication portion 104 in accordance with an operation of the sender.

(f105′-2): A function of delivering the notice of the account setting completion which is received from the account setting portion 302 to the mail communication portion 104.

Similarly, according to the integration, the mail server apparatus 200 and the recipient apparatus 400 are modified so that the recipient apparatus 100′ is to be the transmission and reception source in the case where the transmission and reception source of the first embodiment is the file server apparatus 300.

Even with the abovementioned structure, the similar operation and effect to those of the first embodiment can be obtained.

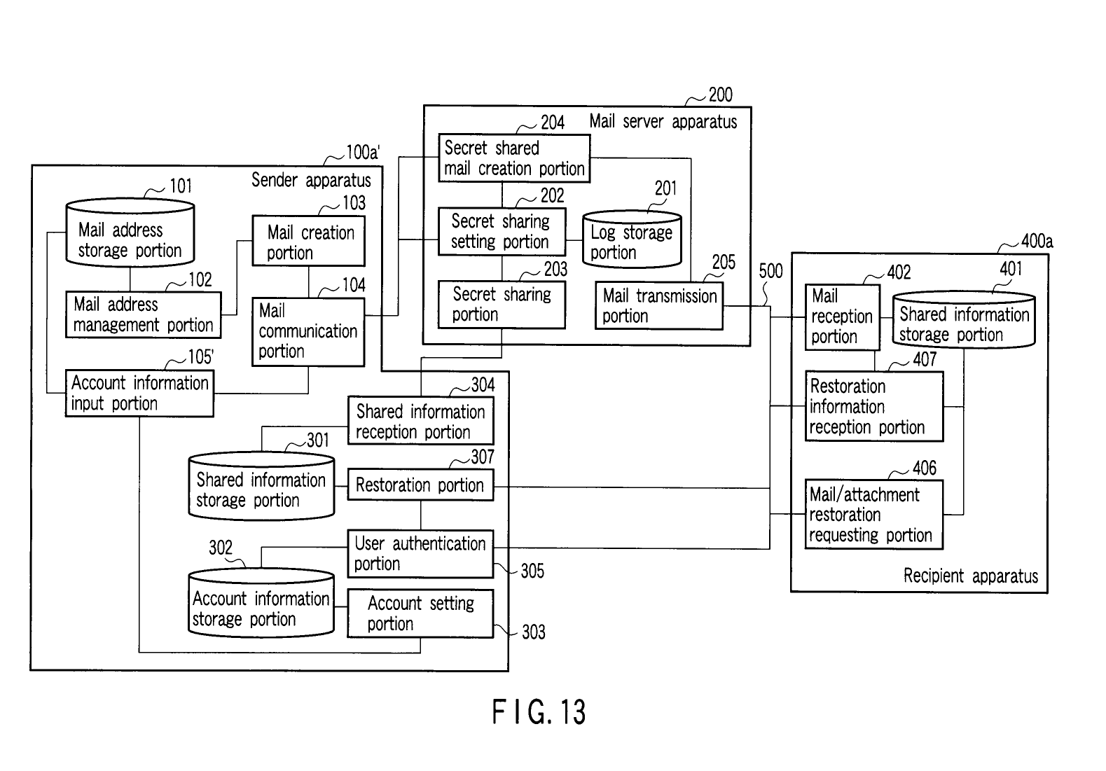

Further, as shown in FIG. 13, the present embodiment can also be modified to provide the sender apparatus 100a′ having a structure in which the file server apparatus 300a in FIG. 8 is integrated with the sender apparatus 100. Even with such modification, the similar operation and effect to those of the second embodiment can be obtained.

### Fourth Embodiment

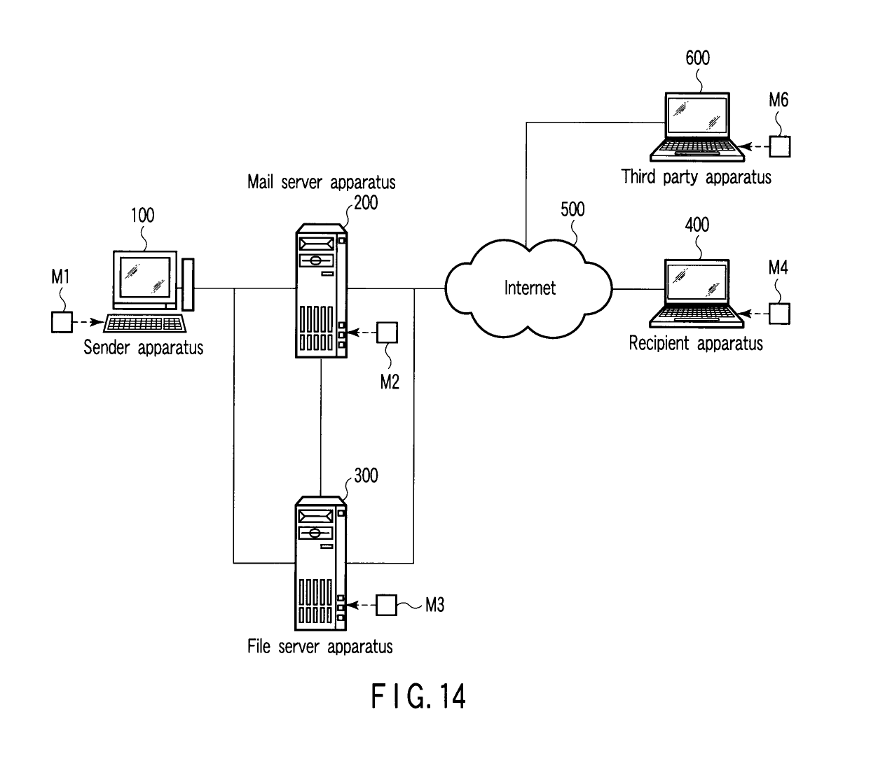

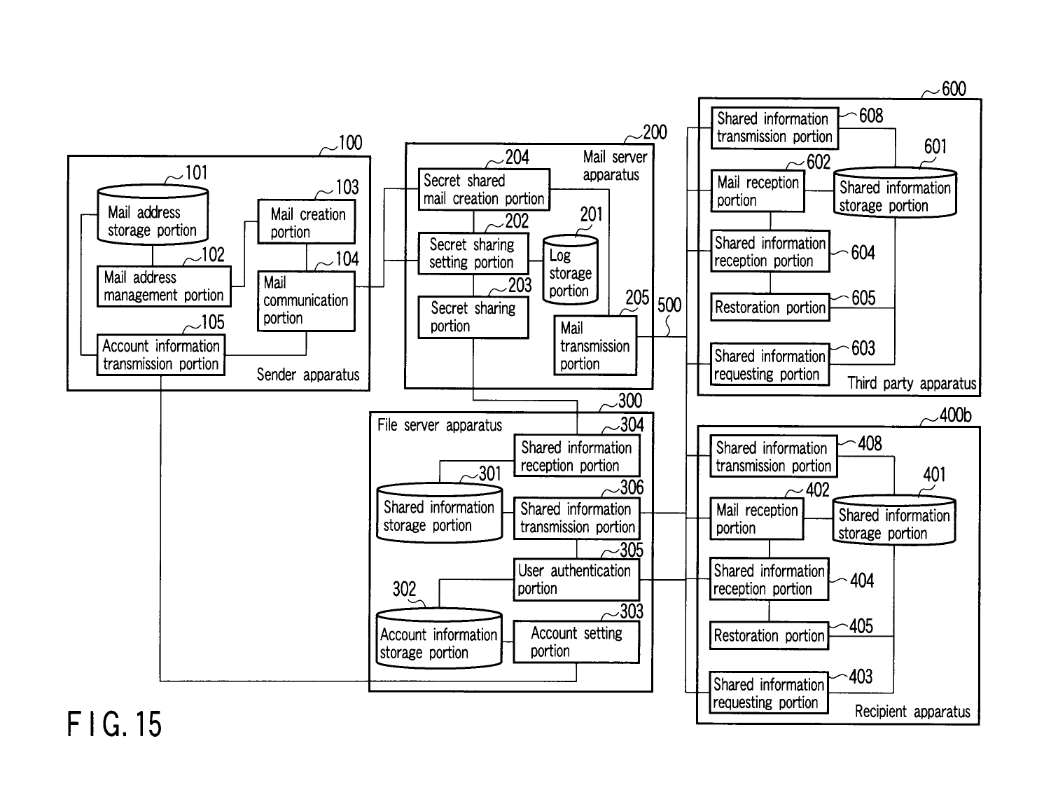

FIGS. 14 and 15 are diagrams showing a structure of an electronic mail system to which the recipient apparatus and the file server apparatus according to the fourth embodiment of the present invention are applied.

The fourth embodiment is a modified example of the first embodiment and has a structure in which a third party apparatus 600 which is connected to the internet 500 is added to the structure shown in FIGS. 1 and 2.

Accordingly, the recipient apparatus 400b has a shared information transmission portion 408 in addition to the structure shown in FIG. 2.

The shared information transmission portion 408 has a function of transmitting the shared data in the shared information storage portion 401 to the third party apparatus 600 when the shared data request is received from the third party apparatus 600. Accordingly, in addition to the abovementioned function, the shared information requesting portion 403 has a function of transmitting the shared data request to the third party apparatus 600 in accordance with an operation of the recipient.

The third party apparatus 600 has the same hardware structure as that of the recipient apparatus 400b and has the similar function to that of the recipient apparatus 400b. Namely, the third party apparatus 600 includes a shared information storage portion 601, a mail reception portion 602, a shared information requesting portion 603, a shared information reception portion 604, a restoration portion 605 and a shared information transmission portion 608 which similarly function as each portion 401 through 405 and 408 of the recipient apparatus 400b.

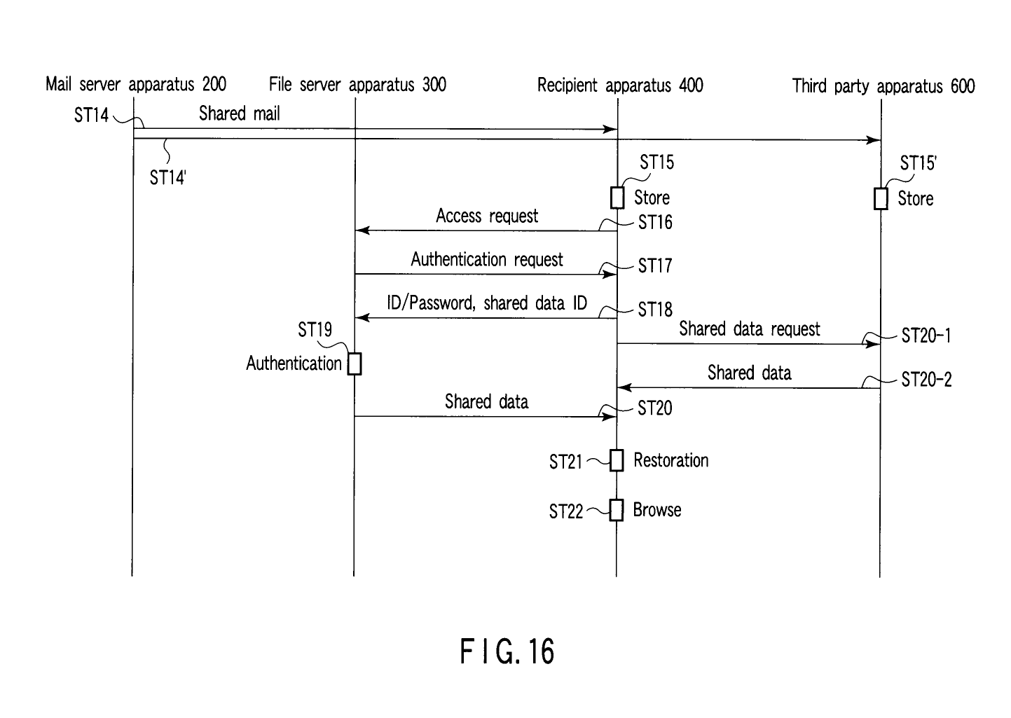

Next, the operation of the electronic mail system which is configured as abovementioned will be explained by utilizing the sequence diagram in FIG. 16. Here, the operation of steps ST1 through ST15 is the same as that of the first embodiment.

In addition, in parallel with steps ST14 and ST15, the mail transmission portion 205 of the mail server apparatus 200 transmits the shared mail to the third party apparatus 600 through the internet 500 (ST14′).

In the third party apparatus 600, the mail reception portion 602 stores the shared mail in the shared mail storage portion 601 when the shared mail is received (ST15′).

(Mail Restoration)

The operation from the access request in step ST16 through the shared data transmission in step ST20 is performed similarly to abovementioned.

In addition, after the completion of step ST18 until the beginning of step ST21, in the recipient apparatus 400b, the shared information requesting portion 403 transmits the shared data request to the third party apparatus 600 in accordance with an operation of the recipient (ST20-1).

In the third party apparatus 600, the shared information transmission portion 608 transmits the shared data in the shared information storage portion 601 to the recipient apparatus 400b when the shared data request is received (ST20-2).

In the recipient apparatus 400b, the restoration portion 405 restores the electronic mail based on the shared data which are respectively received from the file server apparatus 300 and the third party apparatus 600 by the shared information reception portion 404 and the shared data which is included in the shared mail in the shared information storage portion 401 (ST21) and reads the electronic mail (ST22).

Further, with the third party apparatus 600, by performing steps ST16, ST18, ST20-1, ST21, ST22, etc., similarly to the recipient apparatus 400b, it is also possible to restore the electronic mail based on the shared data which are respectively received from the file server apparatus 300 and the recipient apparatus 400b and the shared data which is included in the shared mail in the shared information storage portion 601 and to browse the electronic mail.

As mentioned above, according to the present embodiment, with the structure in which the shared data is transmitted to the file server apparatus 300, the recipient apparatus 400b and the third party apparatus 600 and in which both the recipient apparatus 400b and the third party apparatus 600 can restore the electronic mail, it is possible to apply the invention to the case where the electronic mail is transmitted to a plurality of destinations in addition to the effect of the first embodiment.

### Fifth Embodiment

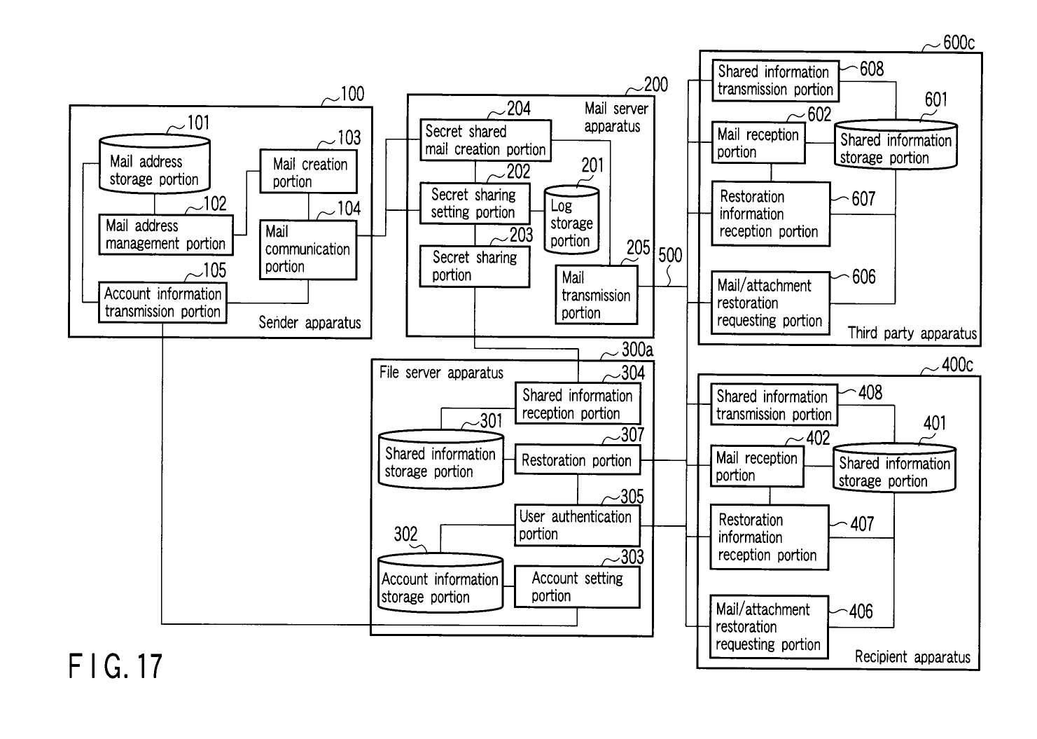

FIG. 17 is a diagram showing a structure of an electronic mail system to which the file server apparatus according to the fifth embodiment of the present invention is applied.

The fifth embodiment is a modified example of the second embodiment and has a structure in which a third party apparatus 600c connected to the internet 500 is added to the structure shown in FIG. 8.

Accordingly, the recipient apparatus 400c has a shared information transmission portion 408 in addition to the structure shown in FIG. 8.

The shared information transmission portion 408 has a function of transmitting the shared data in the shared information storage portion 401 to the third party apparatus 600c when the shared data request is received from the third party apparatus 600c. Accordingly, in addition to the abovementioned function, the mail/attachment restoration requesting portion 406 has a function of transmitting the shared data request to the third party apparatus 600c in accordance with an operation of the recipient.

The third party apparatus 600c has the same hardware structure as that of the recipient apparatus 400c and has the similar function to that of the recipient apparatus 400c. Namely, the third party apparatus 600c has a shared information storage portion 601, a mail reception portion 602, a mail/attachment restoration requesting portion 606, a restoration information reception portion 607 and a shared information transmission portion 608 which similarly function as each portion 401, 402 and 406 through 408 of the recipient apparatus 400c.

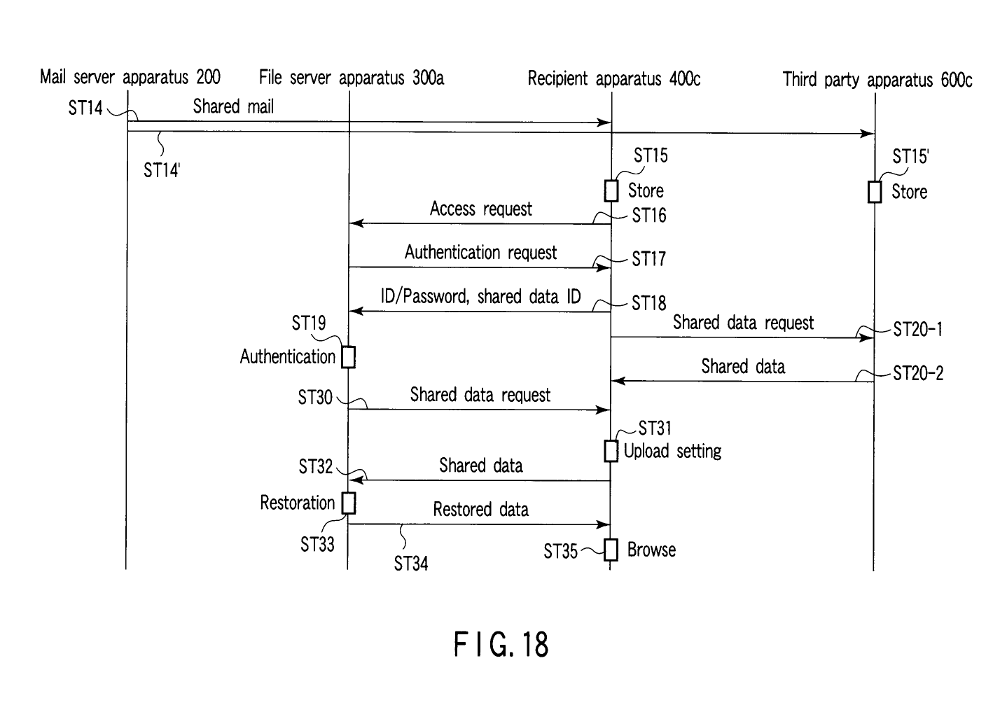

Next, the operation of the electronic mail system which is configured as abovementioned will be explained by utilizing the sequence diagram in FIG. 18. Here, the operation of steps ST1 through ST15 is the same as that of the first embodiment. In addition, in parallel with steps ST14 and ST15, the mail transmission portion 205 of the mail server apparatus 200 transmits the shared mail to the third party apparatus 600c through the internet 500 (ST14′).

In the third party apparatus 600c, the mail reception portion 602 stores the shared mail in the shared mail storage portion 601 when the shared mail is received (ST15′).

(Mail Restoration)

The operation from the access request in step ST16 through user authentication in step ST19 is performed similarly to the abovementioned.

In addition, after step ST18 until the beginning of step ST31, in the recipient apparatus 400c, the shared information requesting portion 403 transmits the shared data request to the third party apparatus 600c in accordance with an operation of the recipient (ST20-1).

In the third party apparatus 600c, the shared information transmission portion 608 transmits the shared data in the shared information storage portion 601 to the recipient apparatus 400c when the shared data request is received (ST20-2). In the recipient apparatus 400c, the shared data is written into the shared data storage portion 401.

In the following, similarly to the abovementioned, the recipient apparatus 400c can browse the restored electronic mail by performing steps ST30 through ST35.

Further, in the third party apparatus 600c, by performing steps ST16, ST18, ST20-1, ST31, ST32, ST35, etc., similarly to the recipient apparatus 400c, it is possible to receive and browse the electronic mail which is restored by the file server apparatus 300a.

As mentioned above, according to the present embodiment, with the structure in which the shared data is transmitted to the file server apparatus 300a, the recipient apparatus 400c and the third party apparatus 600c and in which both the recipient apparatus 400c and the third party apparatus 600c can receive the electronic mail restored by the file server apparatus 300a, it is possible to apply the invention to the case where the electronic mail is transmitted to a plurality of destinations in addition to the effect of the second embodiment.

### Sixth Embodiment

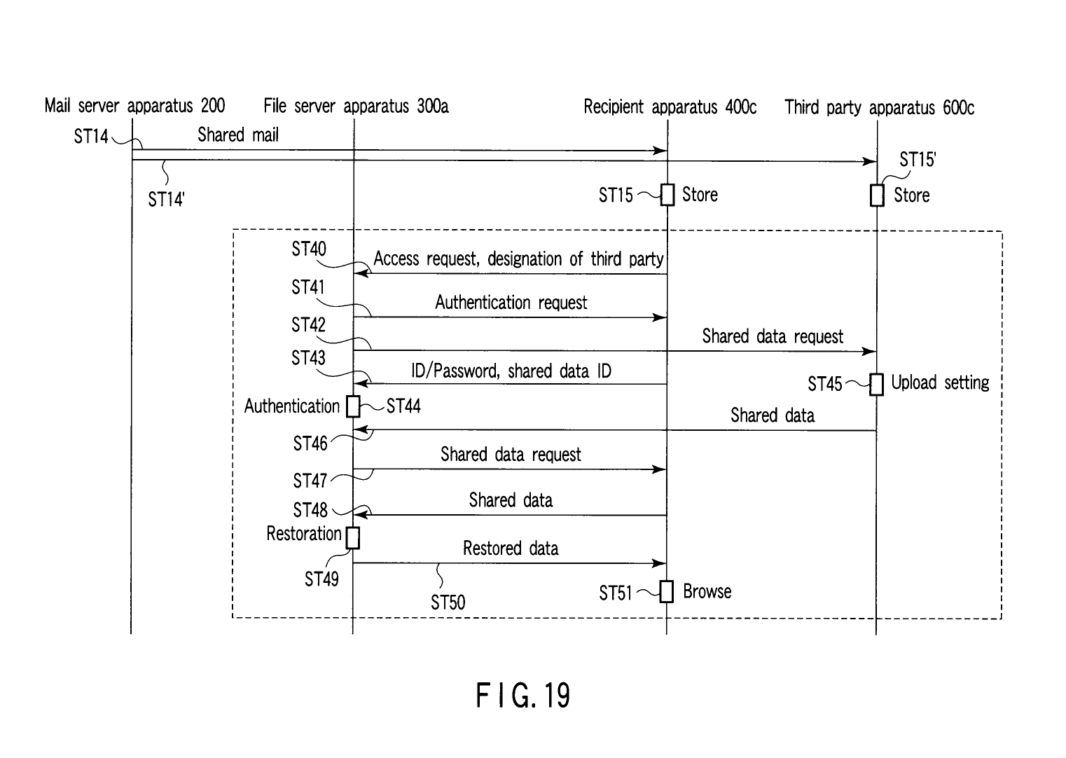

FIG. 19 is a sequence diagram showing operation of an electronic mail system to which the file server apparatus according to a sixth embodiment of the present invention is applied.

The sixth embodiment is a modified example of the fifth embodiment. In the sixth embodiment, the file server apparatus 300a requests the shared data to the third party apparatus 600c unlike the fifth embodiment in which the recipient apparatus 400c requests the shared data to the third party apparatus 600c.

Accordingly, as described in the following, each apparatus of 300a, 400c and 600c is slightly modified. Here, the operation of steps ST1 through ST15, ST14′ and ST15′ is the same as that of the fifth embodiment.

(Mail Restoration)

In the recipient apparatus 400c, the mail/attachment restoration requesting portion 406 transmits the access request which includes the creation date and time information, the destination information, the sender information and subject information in the mail header part of the electronic mail and designated information (user ID or mail address) of the third party apparatus 600c to the file server apparatus 300a in accordance with an operation of the recipient (ST40).

In the file server apparatus 300a, the user authentication portion 305 transmits the authentication request to the recipient apparatus 400c when the access request and the designated information are received (ST41), and the restoration portion 307 transmits the shared data request to the third party apparatus 600c based on the designated information (ST42).

In the recipient apparatus 400c, when the authentication request is received, the shared information requesting portion 403 transmits the user ID, the password and the shared data ID to the file server apparatus 300a in accordance with an operation of the recipient (ST43).

In the file server apparatus 300a, the user authentication portion 305 performs user authentication based on the user information and the account information in the account information storage portion 302 when the user ID, the password and the shared data ID are received (ST44) and delivers the access request described in step ST40 to the restoration portion 307 when authentication is successful.

On the one hand, after step ST42, in the third party apparatus 600c, the shared information transmission portion 608 performs the upload setting of the shared data in the shared information storage portion 601 in accordance with an operation of the recipient when the shared data request is received (ST45) and transmits the shared data to the file server apparatus 300a (ST46).

On the other hand, in the file server apparatus 300a, the restoration portion 307 reads the corresponding shared data in the shared information storage portion 301 based on the creation date and time information, the destination information, the sender information and subject information when the access request is received from the user authentication portion 305 and transmits the shared data request to the recipient apparatus 400c (ST47).

In the recipient apparatus 400c, the mail/attachment restoration requesting portion 406 transmits the shared data in the shared information storage portion 401 to the file server apparatus 300a when the shared data request is received (ST48).

In the file server apparatus 300a, the restoration portion 307 restores the electronic mail based on the shared data which are respectively received from the recipient apparatus 400c and the third party apparatus 600c and the shared data which is read from the shared information storage portion 301 (ST49) and transmits the obtained electronic mail (restored mail in the figure) to the recipient apparatus 400c (ST50).

In the recipient apparatus 400c, the restoration information reception portion 407 browses the electronic mail in the shared information storage portion 401 after writing the received electronic mail into the shared information storage portion 401 (ST51).

Further, in the third party apparatus 600c, by performing steps ST40, ST43, ST48, ST51, etc., similarly to the recipient apparatus 400c, it is possible to receive and browse the electronic mail which is restored by the file server apparatus 300a.

As mentioned above, according to the present embodiment, even in a modification in which the file server apparatus 300a requests the shared data to the third party apparatus 600c, the shared data is transmitted to the file server apparatus 300a, the recipient apparatus 400c and the third party apparatus 600c. Then, both the recipient apparatus 400c and the third party apparatus 600c can receive the electronic mail which is restored by the file server apparatus 300a, as in the fifth embodiment. Therefore, it is possible to apply the invention to the case where the electronic mail is transmitted to a plurality of destinations.

### Seventh Embodiment

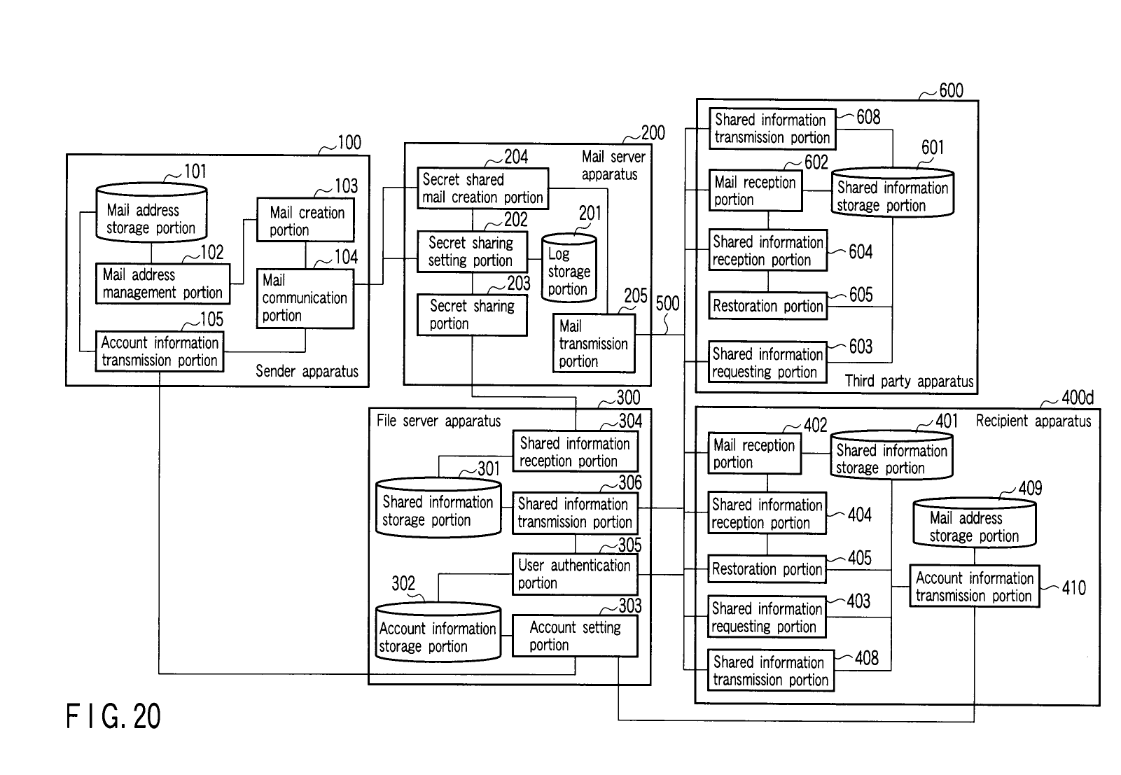

FIG. 20 is a schematic diagram showing a structure of an electronic mail system to which the recipient apparatus and the file server apparatus according to the seventh embodiment of the present invention are applied.

The seventh embodiment is a modified example of the fourth embodiment. The seventh embodiment has the structure in which the sender apparatus 100 sets the account of the recipient apparatus 400d, the recipient apparatus 400d sets the account of the third party apparatus 600 after the recipient apparatus 400d browses the electronic mail, and the third party apparatus 600 browses the electronic mail.

Specifically, in addition to the structure shown in FIG. 15, the recipient apparatus 400d has a mail address storage portion 409 and an account information transmission portion 410.

The mail address storage portion 409 is a storage device which is accessible from the account information transmission portion 410. A user ID, a user name and a mail address for each user are stored in association with one another. Further, address information other than the mail such as an affiliation and a telephone number may be stored. Here, a function of referring to a Lightweight Directory Access Protocol (LDAP) address list may be added to the account information transmission portion 410 and the mail address storage portion 409 may be eliminated.

The account information transmission portion 410 is for transmitting the account information which includes the user ID corresponding to another destination (the third party apparatus 600) and the shared data ID to the file server apparatus 300 after the electronic mail is restored by the restoration portion 405 in the case where a plurality of destinations of the electronic mail exist.

To be more specific, the account information transmission portion 410 has the following functions of (f410-1) through (f410-3).

(f410-1): A function of transmitting the account information which includes the shared data ID and the user ID to the file server apparatus 300 with reference to the user address information in the mail address storage portion 409 and the access list in the account information storage portion 302 of the file server apparatus 300 during the browsing of the electronic mail by the restoration portion 405 in accordance with an operation of the recipient.

(f410-2): A function of receiving the notice of account setting completion from the file server apparatus 300.

(f410-3): A function of transmitting the received notice of the account setting completion to the third party apparatus 600.

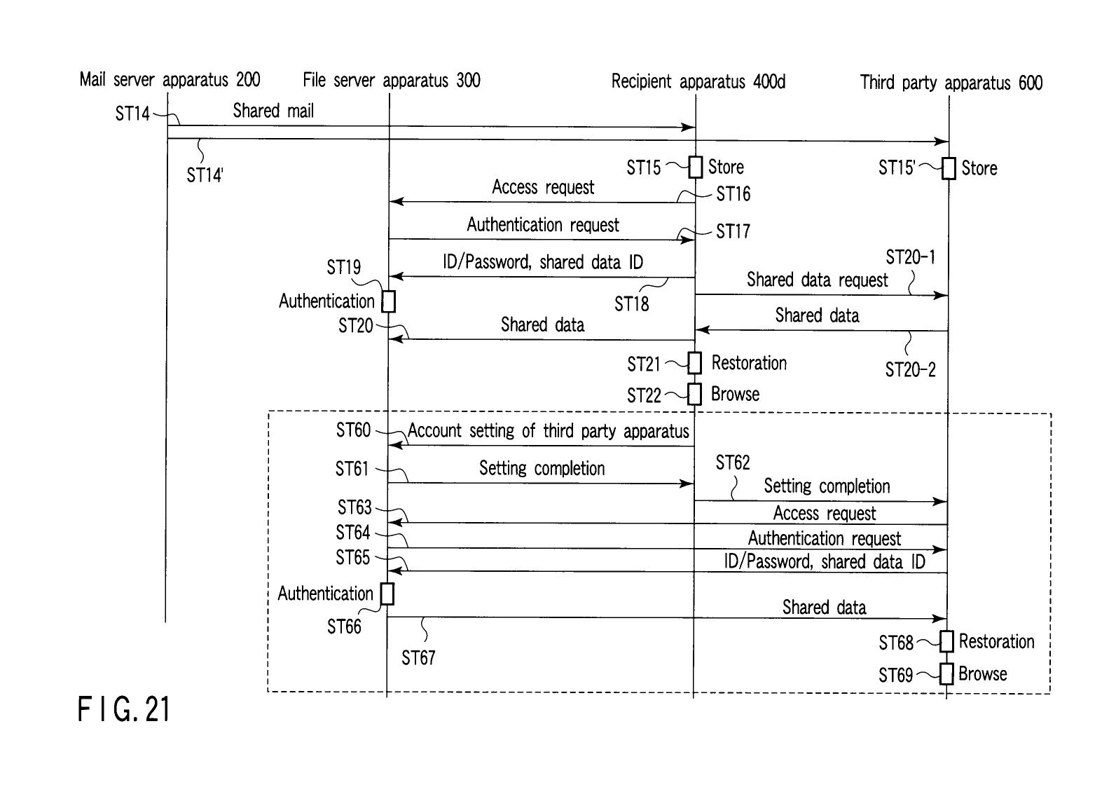

Next, the operation of the electronic mail system which is configured as abovementioned will be explained by utilizing the sequence diagram in FIG. 21. Here, the operation of steps ST1 through ST15, ST14′ and ST15′ is the same as that of the fourth embodiment. However, the account setting in steps ST10 and ST11 is performed only for the recipient of the recipient apparatus 400d.

(Mail Restoration)

The operation of steps ST16 through ST22 is performed similarly to that of the forth embodiment. In the recipient apparatus 400d, the electronic mail is browsed (ST22). Accordingly, the recipient decides whether or not the electronic mail is to be browsed by the third party. In the case where the electronic mail is to be browsed by the third party, the account of the third party apparatus 600 is set to the file server apparatus 300.

Namely, in the recipient apparatus 400d, the account information transmission portion 410 transmits the account information which includes the shared data ID and the user ID (user ID of the third party) to the file server apparatus 300 with reference to the user address information in the mail address storage portion 409 and the access list in the account information storage portion 302 of the file server apparatus 300 during the browsing of the electronic mail by the restoration portion 405 in accordance with an operation of the recipient (ST60).

In the file server apparatus 300, the account setting portion 303 transmits the notice of the account setting completion to the recipient apparatus 400d after writing the account information into the account information storage portion 302 (ST61).

In the recipient apparatus 400d, the notice of the account setting completion is transmitted to the third party apparatus 600 (ST62).

In the third party apparatus 600, when the notice is received, the shared information requesting portion 603 transmits the access request which includes the creation date and time information, the destination information, the sender information and the subject information in the mail header part of the electronic mail to the file server apparatus 300 in accordance with an operation of the third party (ST63).

In the file server apparatus 300, the user authentication portion 305 transmits the authentication request to the third party apparatus 600 when the access request is received (ST64).

In the third party apparatus 600, when the authentication request is received, the shared information requesting portion 603 transmits the user ID, the password and the shared data ID to the file server apparatus 300 in accordance with an operation of the recipient (ST65).

In the file server apparatus 300, the user authentication portion 305 performs user authentication based on the user information and the account information in the account information storage portion 302 when the user ID, the password and the shared data ID are received (ST66) and delivers the access request described in step ST63 to the shared information transmission portion 306 when authentication is successful.

The shared information transmission portion 306 transmits the corresponding shared data in the shared information storage portion 301 to the third party apparatus 600 based on the creation date and time information, the destination information, the sender information and the subject information in the access request when the access request is received (ST67).

In the third party apparatus 600, the restoration portion 405 restores the electronic mail based on the shared data which is received by the shared information reception portion 404 and the shared data which is included in the shared mail stored in step ST15′ (ST68) and browses the electronic mail (ST69).

As mentioned above, in the present embodiment, it is possible that the electronic mail is made to be browsed by the third party apparatus 600 as needed after the electronic mail is browsed at the recipient apparatus 400d, in addition to the effect of the fourth embodiment. In other words, the recipient apparatus 400d can control whether or not the electronic mail is to be browsed by the third party apparatus 600.

### Eighth Embodiment

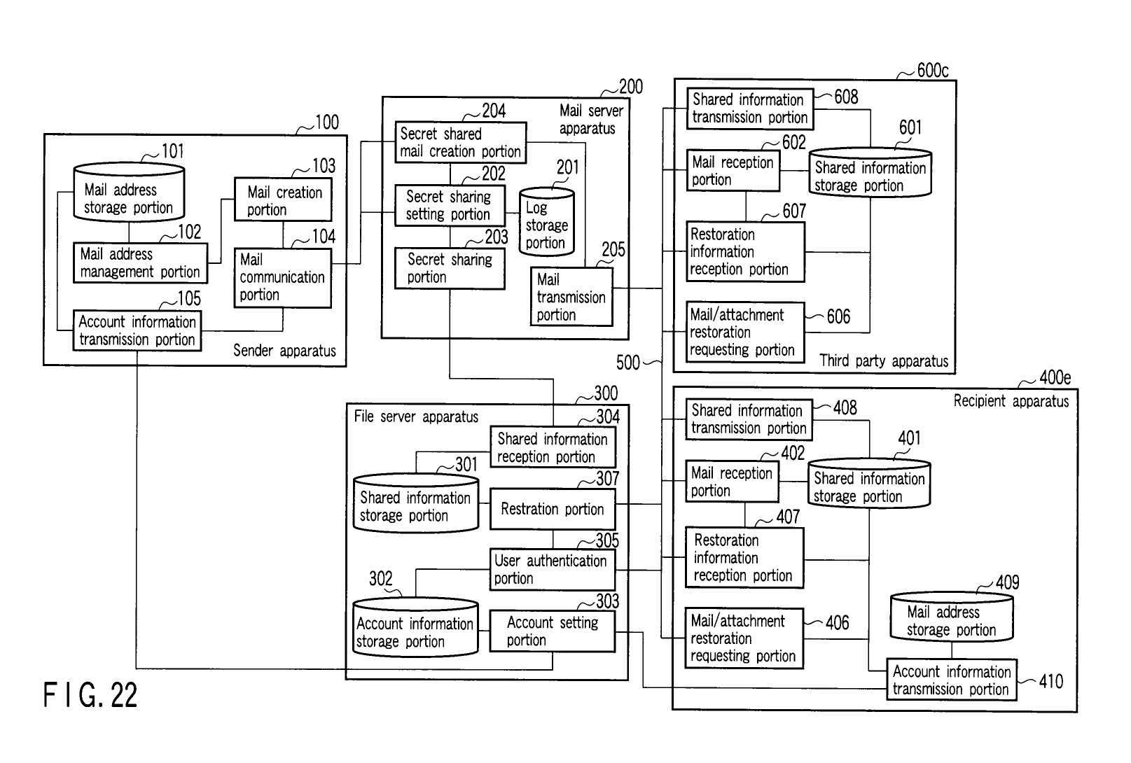

FIG. 22 is a diagram showing a structure of an electronic mail system to which the file server apparatus according to an eighth embodiment of the present invention is applied.

The eighth embodiment is a modified example of the fifth embodiment. The eighth embodiment has the structure in which the sender apparatus 100 sets the account of the recipient apparatus 400e, the recipient apparatus 400e sets the account of the third party apparatus 600c after the recipient apparatus 400e browses the electronic mail, and the third party apparatus 600c browses the electronic mail.

Specifically, in addition to the structure shown in FIG. 17, the recipient apparatus 400e has the mail address storage portion 409 and the account information transmission portion 410.

The mail address storage portion 409 is a storage device which is accessible from the account information transmission portion 410. A user ID, a user name and a mail address for each user are stored in association with one another. Further, address information other than the mail such as an affiliation and a telephone number may be stored.

The account information transmission portion 410 has the following functions of (f410-1) through (f410-3).

(f410-1): A function of transmitting the account information which includes the shared data ID and the user ID to the file server apparatus 300a with reference to the user address information in the mail address storage portion 409 and the access list in the account information storage portion 302 of the file server apparatus 300a during the browsing of the electronic mail which is received from the restoration information reception portion 407 in accordance with an operation of the recipient.

(f410-2): A function of receiving the notice of account setting completion from the file server apparatus 300a.

(f410-3): A function of transmitting the received notice of the account setting completion to the third party apparatus 600c.

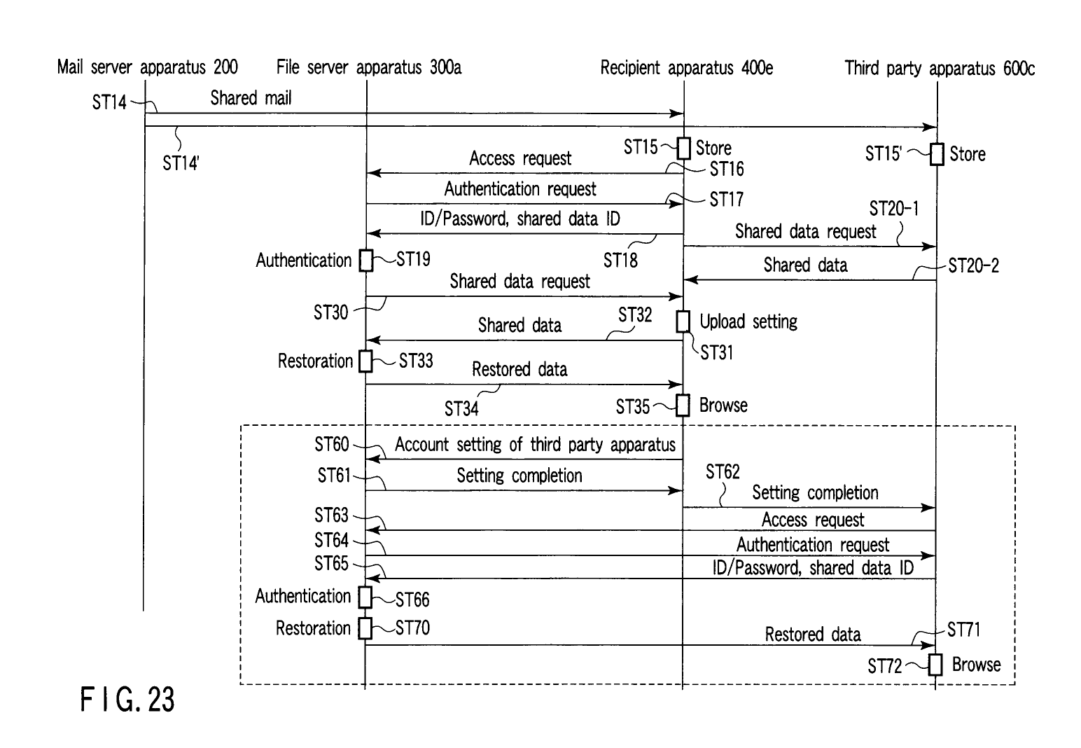

Next, the operation of the electronic mail system which is configured as abovementioned will be explained by utilizing the sequence diagram in FIG. 23. Here, the operation of steps ST1 through ST15, ST14′ and ST15′ is the same as that of the fifth embodiment. However, the account setting in steps ST10 and ST11 is performed only for the recipient of the recipient apparatus 400e.

(Mail Restoration)

The operation of steps 16 through ST20-2 and steps ST30 through ST35 is performed similarly to that of the fifth embodiment. In the recipient apparatus 400e, the electronic mail is browsed (ST35). Accordingly, the recipient decides whether or not the electronic mail is to be browsed by the third party. In the case where the electronic mail is to be browsed by the third party, the account of the third party apparatus 600c is set to the file server apparatus 300a.

Here, similarly to the seventh embodiment, the operation from account setting in step ST60 through user authentication in step ST60 is performed.

In step ST66, when the user ID, the password and the shared data ID are received, the user authentication portion 305 performs user authentication based on the user information and the account information in the account information storage portion 302. When user authentication is successful, the access request described in step ST63 is delivered to the restoration portion 307.

In the file server apparatus 300a, the restoration portion 307 restores the electronic mail based on the corresponding shared data in the shared information storage portion 301 and the shared data which is received from the recipient apparatus 400e in step ST31 in accordance with the creation date and time information, the destination information, the sender information and the subject information when the access request is received from the user authentication portion 305 (ST70) and transmits the obtained electronic mail (restored mail in the figure) to the third party apparatus 600c (ST71).

In the third party apparatus 600c, the restoration information reception portion 607 browses the electronic mail in the shared information storage portion 601 after writing the received electronic mail into the shared information storage portion 601 (ST72).

As mentioned above, in the present embodiment, it is possible that the electronic mail is made to be browsed by the third party apparatus 600c as needed after the electronic mail is browsed at the recipient apparatus 400e, in addition to the effect of the fifth embodiment. In other words, the recipient apparatus 400e can control whether or not the electronic mail is to be browsed by the third party apparatus 600c.

### Ninth Embodiment

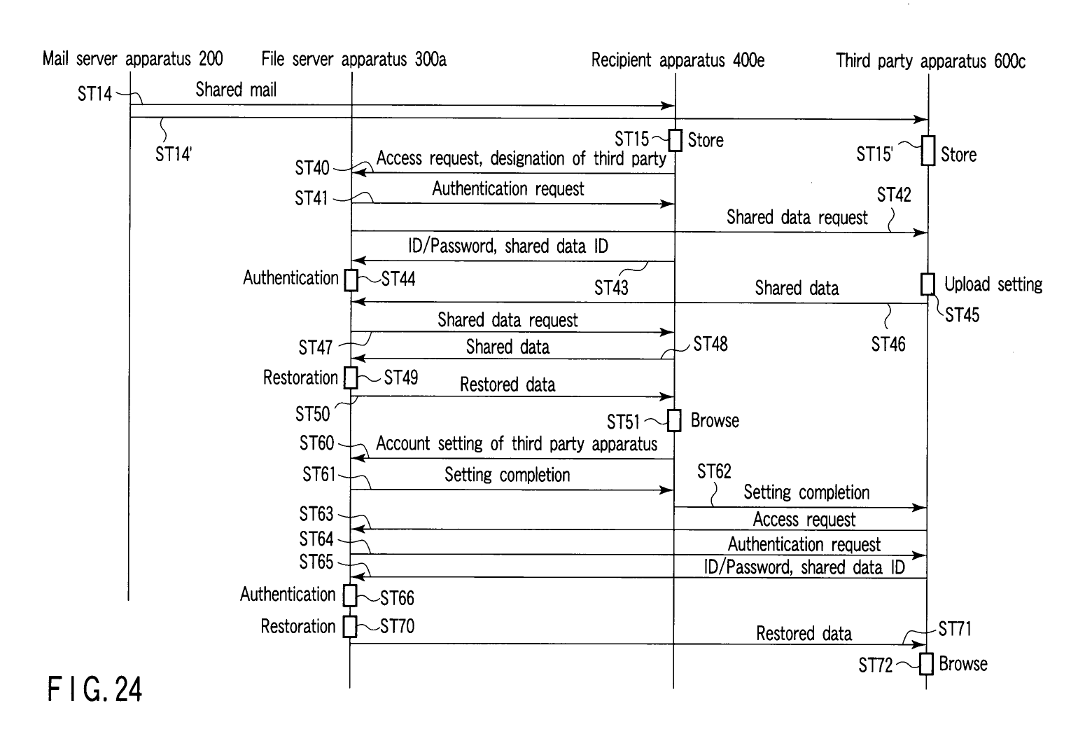

FIG. 24 is a sequence diagram showing an operation of an electronic mail system to which the file server apparatus according to a ninth embodiment of the present invention is applied.

The ninth embodiment is a modified example of the eighth embodiment. The ninth embodiment has the structure in which steps ST40 through ST51 of the sixth embodiment are adopted in place of steps ST16 through ST35 of the eighth embodiment.

With the abovementioned structure, the effects of the sixth and eighth embodiments can be obtained.

### Tenth Embodiment

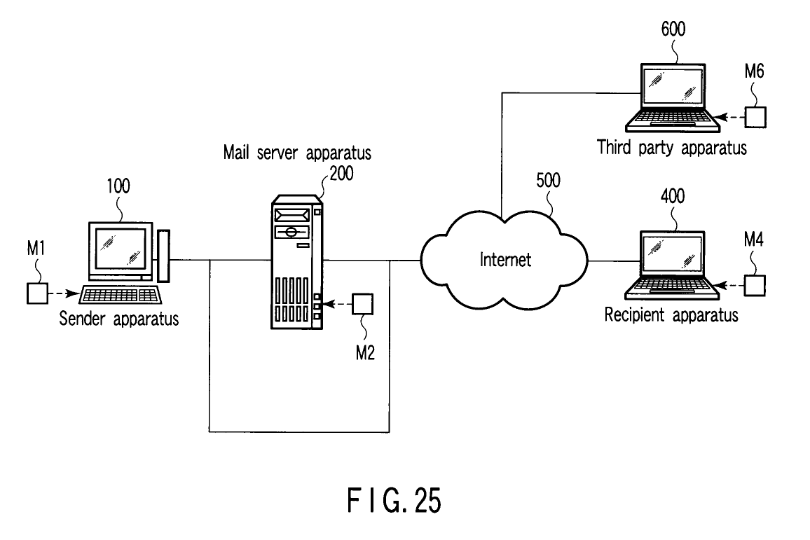

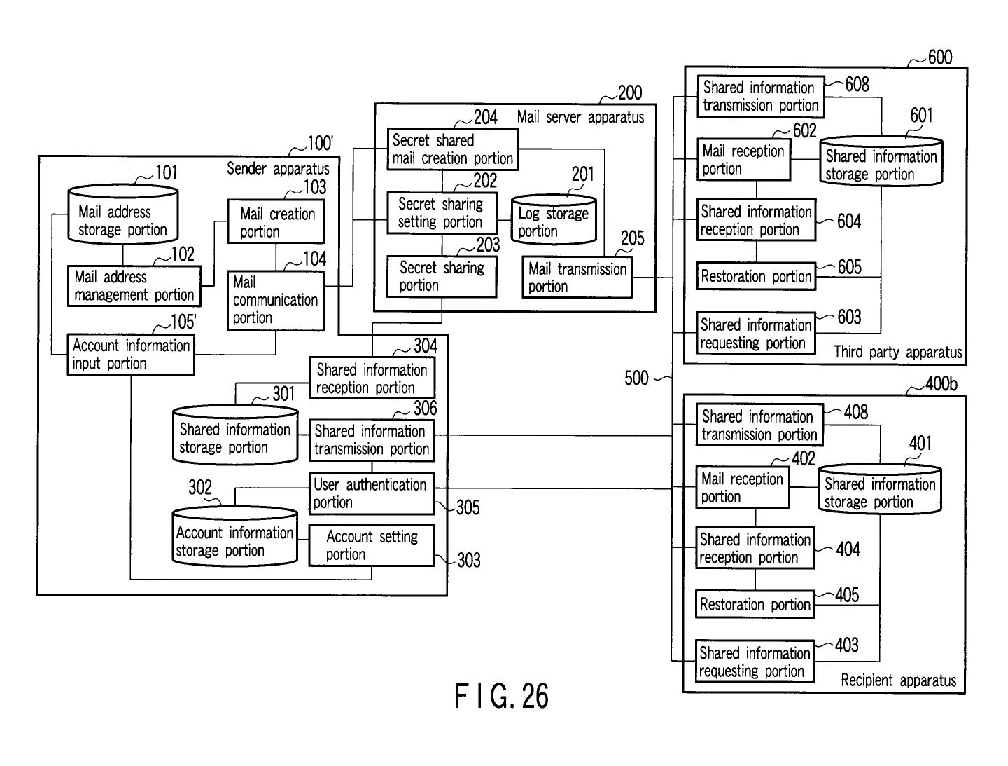

FIGS. 25 and 26 are diagrams showing a structure of an electronic mail system to which the recipient apparatus according to a tenth embodiment of the present invention is applied.

The tenth embodiment is a modified example of the fourth embodiment. As shown in FIG. 26, the tenth embodiment has the sender apparatus 100′ which is configured to integrate the file server apparatus 300 in FIG. 15 with the sender apparatus 100. Here, according to the integration, an account information input portion 105′ is provided in place of the account information transmission portion 105 shown in FIG. 15.

The account information input portion 105′ has the following functions of (f105′-1) and (f105′-2).

(f105′-1): A function of inputting the account information which includes the shared data ID and the user ID to the account setting portion 303 with reference to the user address information in the mail address storage portion 101 and the access list in the account information storage portion 302 based on the account creation request which is received from the mail communication portion 104 in accordance with an operation of the sender.

(f105′-2): A function of delivering the notice of the account setting completion which is received from the account setting portion 303 to the mail communication portion 104.

Similarly, according to the integration, the mail server apparatus 200 and the recipient apparatus 400b are modified so that the recipient apparatus 100′ is to be the transmission and reception source in the case where the transmission and reception source of the fourth embodiment is the file server apparatus 300.

Even with the abovementioned structure, the similar operation and effect to those of the fourth embodiment can be obtained.

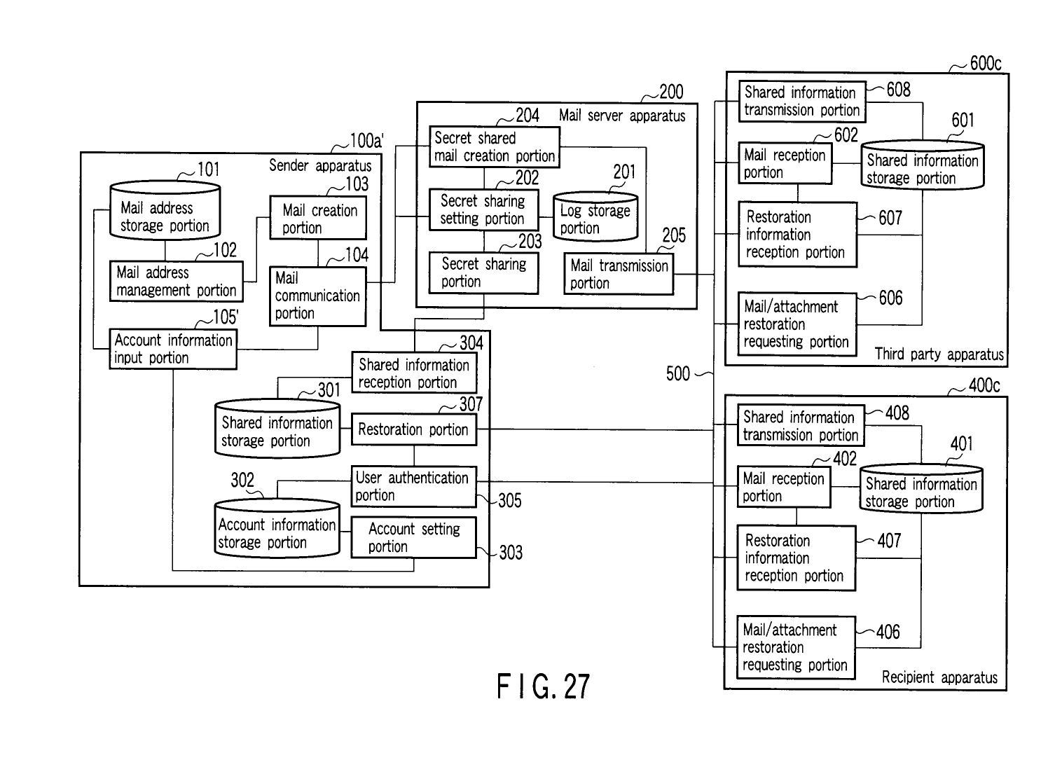

Further, the present embodiment can be modified to have the sender apparatus 100a′ which is configured to integrate the file server apparatus 300a in FIG. 17 with the sender apparatus 100, as shown in FIG. 27. Even with this modification, the similar operation and effect to those of the fifth or sixth embodiment can be obtained.

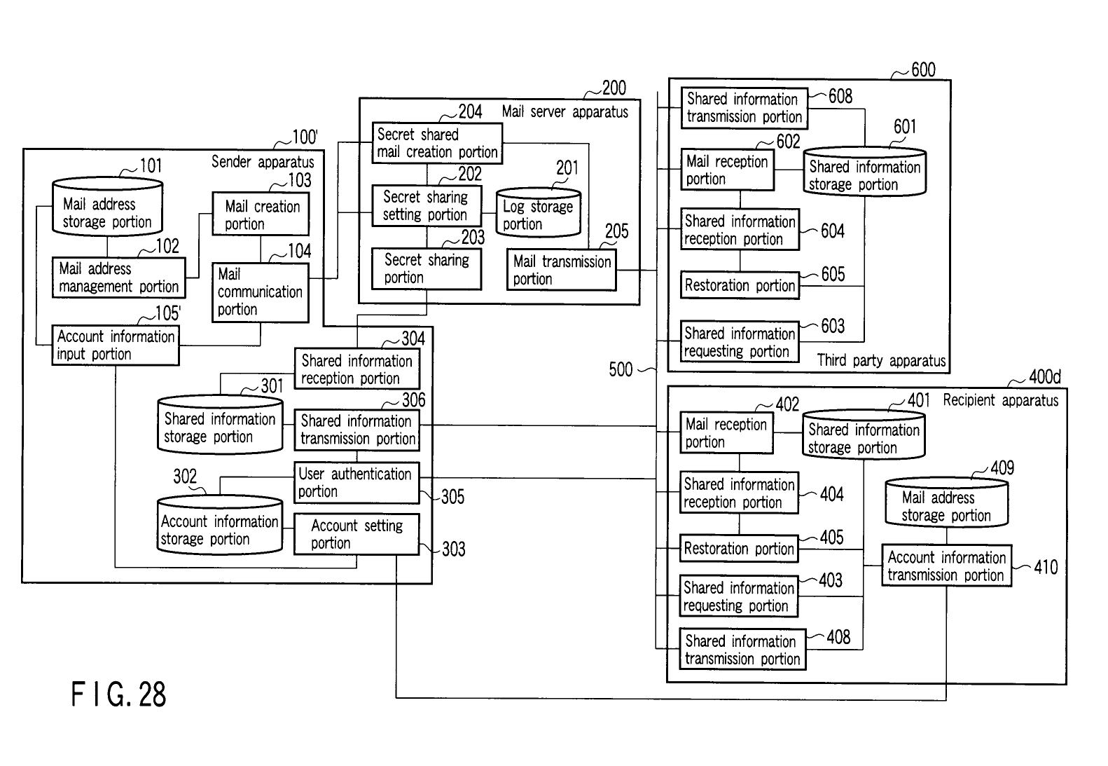

Further, the present embodiment can be modified to have the sender apparatus 100′ which is configured to integrate the file server apparatus 300 in FIG. 20 with the sender apparatus 100, as shown in FIG. 28. Even with this modification, the similar operation and effect to those of the seventh embodiment can be obtained.

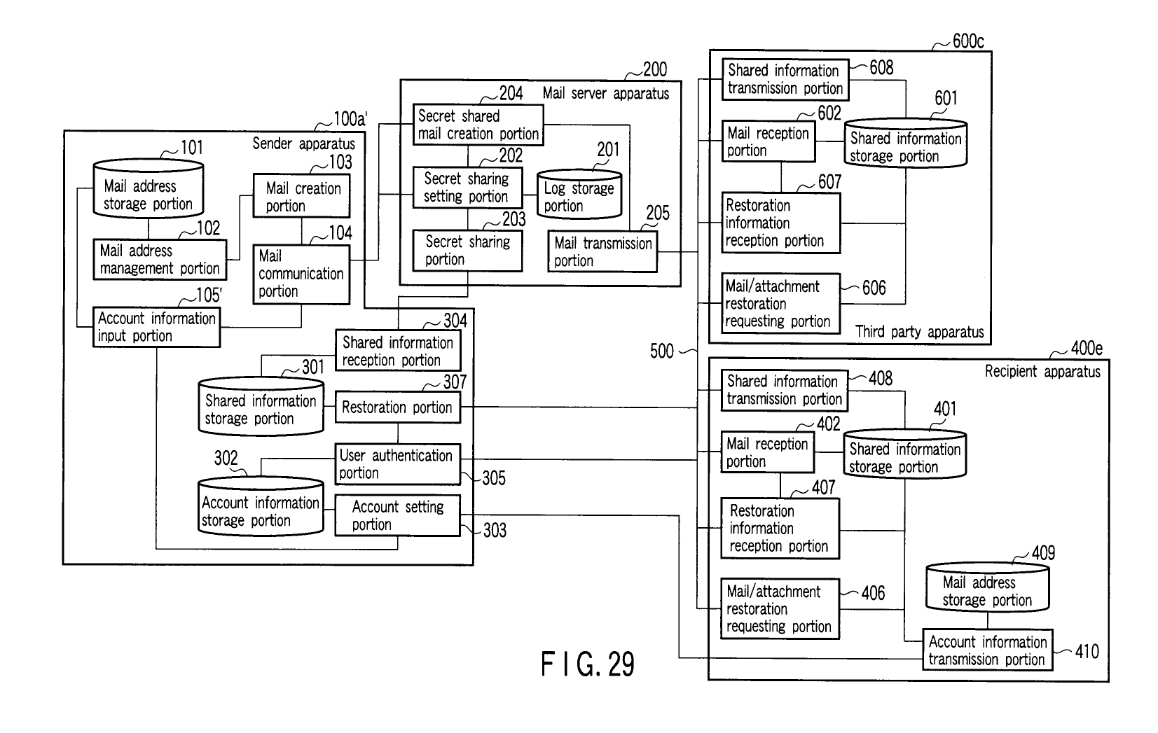

Furthermore, the present embodiment can be modified to have the sender apparatus 10a′ which is configured to integrate the file server apparatus 300a in FIG. 22 with the sender apparatus 100, as shown in FIG. 29. Even with this modification, the similar operation and effect to those of the eighth or ninth embodiment can be obtained.

### Eleventh Embodiment

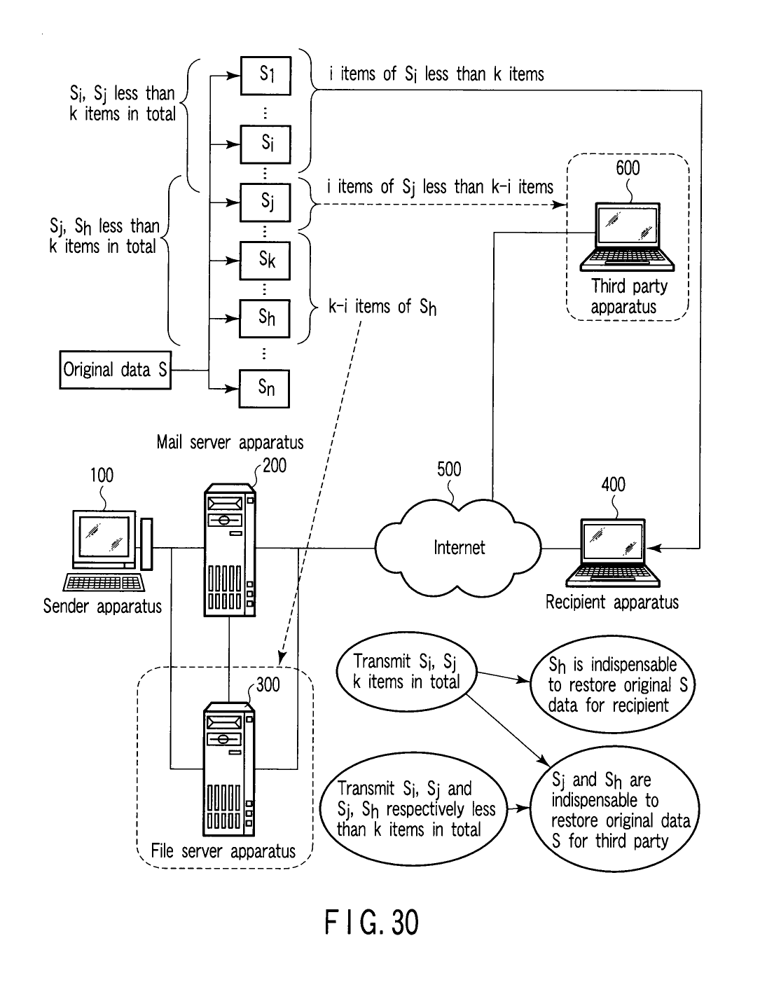

FIG. 30 is a schematic diagram showing an arrangement of shared data of an electronic mail system to which the recipient apparatus and the file server apparatus according to an eleventh embodiment of the present invention are applied.

The eleventh embodiment is a modified example of the fourth embodiment. In this embodiment, when the electronic mail is restored, the shared data request to the third party apparatus 600 can be omitted while the shared data in the file server apparatus 300 and the recipient apparatus 400 are indispensable.

Specifically, at the mail server apparatus 200, the secret sharing portion 203 generates n items of shared data S₁, . . . , Sₙ from the electronic mail S in accordance with the secret sharing method of the threshold value k and the sharing number n in step ST4.

Here, in step ST14, i items of shared data Sᵢ, which are less than k items, out of n items of shared data S₁, . . . , Sₙ are transmitted to the recipient apparatus 400. Further, in step ST5, k-i items of shared data Sₕ are transmitted to the file server apparatus 300. Furthermore, in step ST14′, the shared data Sⱼ which are less than k-i items and less than i items are transmitted to the third party apparatus 600. Here, each shared data Sᵢ, Sₕ and Sⱼ does not overlap one another.

Accordingly, the total of i items of shared data Sᵢ and k-i items of shared data Sₕ becomes k items. Therefore, the recipient apparatus 400 which has the shared data Sᵢ can restore the electronic mail in the case where the shared data Sₕ is obtained from the file server apparatus 300.

On the other hand, since the total of the shared data Sⱼ which is less than k-i items and less than i items with either of i items of shared data Sᵢ or k-i items of shared data Sₕ does not become k items, the third party apparatus 600 which has the shared data S cannot restore the electronic mail unless the shared data Sₕ, Sᵢ are obtained from both the file server apparatus 300 and the recipient apparatus 400.

As mentioned above, in the present embodiment, the shared data request from the recipient apparatus 400 to the third party apparatus 600 can be omitted in addition to the effect of the fourth embodiment.

Here, not limited to the fourth embodiment, when the present embodiment is similarly applied to any one of the fifth to tenth embodiments which have the third party apparatus 600 or 600c, the shared data request from the recipient apparatuses 400b through 400e to the third party apparatus 600 or 600c can be omitted in addition to the effect of the present embodiment.

The technique described above for the embodiment can be stored as a program to be executed by a computer in memory mediums including magnetic disks (Floppy™ disks, hard disks, etc.), optical disks (CD-ROMs, DVDs, etc.), magneto-optical disks (MOs) and semiconductor memories for distribution.

Memory mediums that can be used for the purpose of the present invention are not limited to those listed above and memory mediums of any type can also be used for the purpose of the present invention so long as they are computer-readable ones.

Additionally, the OS (operating system) operating on a computer according to the instructions of a program installed in the computer from a memory medium, data base management software and/or middleware such as network software may take part in each of the processes for realizing the above embodiment.

Still additionally, memory mediums that can be used for the purpose of the present invention are not limited to those independent from computers but include memory mediums adapted to download a program transmitted by LANs and/or the Internet and permanently or temporarily store it.

It is not necessary that a single memory medium is used with the above described embodiment. In other words, a plurality of memory mediums may be used with the above-described embodiment to execute any of the above described various processes. Such memory mediums may have any configuration.

For the purpose of the present invention, a computer executes various processes according to one or more than one programs stored in the memory medium or mediums as described above for the preferred embodiment. More specifically, the computer may be a stand alone computer or a system realized by connecting a plurality of computers by way of a network.

For the purpose of the present invention, computers include not only personal computers but also processors and microcomputers contained in information processing apparatus. In other words, computers generally refer to apparatus and appliances that can realize the functional features of the present invention by means of a computer program.

The present invention is by no means limited to the above described embodiment, which may be modified in various different ways without departing from the spirit and scope of the invention. Additionally, any of the components of the above described embodiment may be combined differently in various appropriate ways for the purpose of the present invention. For example, some of the components of the above described embodiment may be omitted. Alternatively, components of different embodiments may be combined appropriately in various different ways for the purpose of the present invention.

What is claimed is:

1. A recipient apparatus capable of communicating with each of a mail server apparatus and a file server apparatus, comprising:
a storage device to store a remaining shared mail other than a part of shared mails in the case where the mail server apparatus creates a shared data ID and a plurality of shared mails including a plurality of shared data and a header part of an electronic mail by performing secret sharing of a message main body of the electronic mail which is transmitted from a sender apparatus and the file server apparatus receives the part of the shared mails out of the shared mails;
a device configured to write the remaining shared mail into the storage device when the remaining shared mail is received from the mail server apparatus;
a device configured to transmit an access request including creation date and time information, destination information, sender information and subject information in the header part to the file server apparatus;
a device configured to transmit account information including an input user ID and the shared data ID to the file server apparatus when an authentication request is received from the file server apparatus after the transmission of the access request; and
a restoration device configured to restore the electronic mail based on a part of the shared data received from the file server apparatus and the shared data included in the remaining shared mail in the storage device after the file server apparatus performs an authentication based on the account information.

2. The recipient apparatus according to claim 1, further comprising an account information transmission device configured to transmit account information including a user ID corresponding to other destination and a shared data ID to the file server apparatus after the electronic mail is restored by the restoration device in the case where a plurality of destinations of the electronic mail exist.

3. A file server apparatus capable of communicating with each of a mail server apparatus and a recipient apparatus, comprising:
a shared mail storage device to store a remaining shared mail other than a part of shared mails in the case where the mail server apparatus creates a shared data ID and a plurality of shared mails including a plurality of shared data and a header part of an electronic mail by performing secret sharing of a message main body of the electronic mail which is transmitted from a sender apparatus and the recipient apparatus receives the part of the shared mails out of the shared mails;
an account information storage device which stores account information including a user ID and a shared data ID;
a device configured to write the account information transmitted from the sender apparatus into the account information storage device;
a device configured to write the remaining shared mail into the shared mail storage device when the remaining shared mail is received from the mail server apparatus;
a device configured to transmit an authentication request to the recipient apparatus when an access request including creation date and time information, destination information, sender information and subject information in the header part is received from the recipient apparatus;
a device configured to receive account information including a user ID and a shared data ID from the recipient apparatus after the transmission of the authentication request;
a device configured to authenticate the recipient apparatus based on the account information received from the recipient apparatus and the account information in the account information storage device and to deliver the access request when authentication is successful; and
a device configured to transmit the corresponding shared data in the shared mail storage device to the recipient apparatus based on the delivered access request.

4. The file server apparatus according to claim 3, further comprising a device configured to write the account information including the user ID and the shared data ID and transmitted from the recipient apparatus into the account information storage device.

5. A file server apparatus capable of communicating with each of a mail server apparatus and a recipient apparatus, comprising:
a shared mail storage device to store a remaining shared mail other than a part of shared mails in the case where the mail server apparatus creates a shared data ID and a plurality of shared mails including a plurality of shared data and a header part of an electronic mail by performing secret sharing of a message main body of the electronic mail which is transmitted from a sender apparatus and the recipient apparatus receives the part of the shared mails out of the shared mails;
an account information storage device which stores account information including a user ID and a shared data ID;
a device configured to write the account information transmitted from the sender apparatus into the account information storage device;
a device configured to write the remaining shared mail into the shared mail storage device when the remaining shared mail is received from the mail server apparatus;
a device configured to transmit an authentication request to the recipient apparatus when an access request including creation date and time information, destination information, sender information and subject information in the header part is received from the recipient apparatus;
a device configured to receive account information including a user ID and a shared data ID from the recipient apparatus after the transmission of the authentication request;
a device configured to authenticate the recipient apparatus based on the account information received from the recipient apparatus and the account information in the account information storage device and to deliver the access request when authentication is successful;
a device configured to read the shared data corresponding to the delivered access request from the shared mail storage device;
a device configured to transmit a shared data request to the recipient apparatus when authentication is successful;
a device configured to restore the electronic mail based on the shared data received from the recipient apparatus and the shared data read from the shared mail storage device after the transmission of the shared data request; and
a device configured to transmit the restored electronic mail to the recipient apparatus.

6. The file server apparatus according to claim 5, further comprising a device configured to write the account information including the user ID and the shared data ID and transmitted from the recipient apparatus into the account information storage device.

7. A program stored in a computer-readable storage medium for use in a recipient apparatus capable of communicating with each of a mail server apparatus and a file server apparatus and having a storage device, comprising:
first program code which makes the recipient apparatus execute a process to write a remaining shared mail into the storage device when the remaining shared mail other than a part of shared mails is received from the mail server apparatus in the case where the mail server apparatus creates a shared data ID and a plurality of shared mails including a plurality of shared data and a header part of an electronic mail by performing secret sharing of a message main body of the electronic mail which is transmitted from a sender apparatus and the file server apparatus receives the part of the shared mails out of the shared mails;
second program code which makes the recipient apparatus execute a process to transmit an access request including creation date and time information, destination information, sender information and subject information in the header part to the file server apparatus;
third program code which makes the recipient apparatus execute a process to transmit account information including an input user ID and the shared data ID to the file server apparatus when an authentication request is received from the file server apparatus after the transmission of the access request; and
fourth program code which makes the recipient apparatus execute a process to restore the electronic mail based on a part of the shared data received from the file server apparatus and the shared data included in the remaining shared mail in the storage device after the file server apparatus performs an authentication based on the account information.

8. A program stored in a computer-readable storage medium for use in a file server apparatus capable of communicating with a mail server apparatus and a recipient apparatus and having an account information storage device and a shared mail storage device, comprising:
first program code which makes the file server apparatus execute a process to write the account information including a user ID and a shared data ID and transmitted from a sender apparatus into the account information storage device;
second program code which makes the file server apparatus execute a process to write a remaining shared mail into the shared mail storage device when the remaining shared mail other than a part of shared mails is received from the mail server apparatus in the case where the mail server apparatus creates a shared data ID and a plurality of shared mails including a plurality of shared data and a header part of an electronic mail by performing secret sharing of a message main body of the electronic mail which is transmitted from a sender apparatus and the file server apparatus receives the part of the shared mails out of the shared mails;
third program code which makes the file server apparatus execute a process to transmit an authentication request to the recipient apparatus when an access request including creation date and time information, destination information, sender information and subject information in the header part is received from the recipient apparatus;
fourth program code which makes the file server apparatus execute a process to receive account information including a user ID and a shared data ID from the recipient apparatus after the transmission of the authentication request;
fifth program code which makes the file server apparatus execute a process to authenticate the recipient apparatus based on the account information received from the recipient apparatus and the account information in the account information storage device and to deliver the access request when authentication is successful; and
sixth program code which makes the file server apparatus execute a process to transmit the corresponding shared data in the shared mail storage device to the recipient apparatus based on the delivered access request.

9. A program stored in a computer-readable storage medium for use in a file server apparatus capable of communicating with a mail server apparatus and a recipient apparatus and having an account information storage device and a shared mail storage device, comprising:
first program code which makes the file server apparatus execute a process to write the account information including a user ID and a shared data ID and transmitted from a sender apparatus into the account information storage device;
second program code which makes the file server apparatus execute a process to write a remaining shared mail into the shared mail storage device when the remaining shared mail other than a part of shared mails is received from the mail server apparatus in the case where the mail server apparatus creates a shared data ID and a plurality of shared mails including a plurality of shared data and a header part of an electronic mail by performing secret sharing of a message main body of the electronic mail which is transmitted from a sender apparatus and the file server apparatus receives the part of the shared mails out of the shared mails;
third program code which makes the file server apparatus execute a process to transmit an authentication request to the recipient apparatus when an access request including creation date and time information, destination information, sender information and subject information in the header part is received from the recipient apparatus;
fourth program code which makes the file server apparatus execute a process to receive account information including a user ID and a shared data ID from the recipient apparatus after the transmission of the authentication request;
fifth program code which makes the file server apparatus execute a process to authenticate the recipient apparatus based on the account information received from the recipient apparatus and the account information in the account information storage device and to deliver the access request when authentication is successful;
sixth program code which makes the file server apparatus execute a process to read the shared data corresponding to the delivered access request from the shared mail storage device;
seventh program code which makes the file server apparatus execute a process to transmit a shared data request to the recipient apparatus when authentication is successful;
eighth program code which makes the file server apparatus execute a process to restore the electronic mail based on the shared data received from the recipient apparatus and the shared data read from the shared mail storage device after the transmission of the shared data request; and
ninth program code which makes the file server apparatus execute a process to transmit the restored electronic mail to the recipient apparatus.
